(19) United States
(12) Patent Application Publication
(10) Pub. No.: US 2005/0055710 A1
(43) Pub. Date: Mar. 10, 2005

(54) Motion picture storage apparatus and motion picture distributing system

(75) Inventors: Hisashi Aoki, Kanagawa (JP); Tatsuaki Iwata, Kanagawa (JP); Noboru Yamaguchi, Saitama (JP); Tadaaki Masuda, Tokyo (JP); Tomoya Kodama, Kanagawa (JP); Koichi Masukura, Kanagawa (JP); Atsushi Matsumura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/717,539

(22) Filed: Nov. 21, 2003

(30) Foreign Application Priority Data
Nov. 22, 2002 (JP) P.2002-338742
Dec. 12, 2002 (JP) P.2002-360227

(51) Int. Cl. H04N 7/025; H04N 7/10

(52) U.S. Cl. 725/32; 725/135

(57) ABSTRACT

A motion picture storage apparatus includes: a motion picture input unit which inputs motion picture data; a motion picture storage unit which sequentially stores the motion picture data; a condition storage unit which stores a condition related to a desirable scene previously set by a user; a motion picture analyzing unit configured to analyze the motion picture data stored in the motion picture storage unit to check whether a scene satisfying the condition is present, and configured to acquire specifying information of the scene satisfying the condition when the scene satisfying the condition is present; and an information notifying unit which notifies the specifying information to a device of the user.

The present disclosure relates to the subject matters contained in Japanese Patent Application Nos. 2002-338742 and 2002-360227, filed Nov. 22, 2002 and Dec. 12, 2002, which are incorporated herein by reference in their entirety.

### BACKGROUND OF THE INVENTION

1. Field of the Invention

The present invention relates to a motion picture storage apparatus for storing motion picture data which have been distributed from external sources and for transmitting the stored motion picture data to portable viewing device of users. The present invention also relates to a motion picture distributing system using the motion picture storage apparatus.

2. Background Art

Since rapid progress can be established in motion picture processing techniques, generally speaking, motion picture information has been distributed, viewed, stored, and edited as digital data in accordance with the international standard formats of MPEG-1, MPEG-2, and MPEG-4.

Very recently, various types of services have been practically provided in such a manner that not only digital motion pictures are handled by utilizing video appliances and computers, but also digital motion pictures are viewed on portable devices. Also, in order to transmit/receive motion picture information, the motion picture data have been transmitted/received via various sorts of media such as not only the conventional ground wave broadcasting and the conventional satellite broadcasting, but also cable television, the Internet, and cellular phones.

To utilize motion pictures in easier and simpler manners, needs are largely made to edit, retrieve, manage, and distribute these motion pictures in response to metadata such as features and implication information of the motion pictures. Such a motion picture storage server has been so far proposed (for example, JP-A-10-42234). That is, this motion picture storage server checks performers from captions of TV programs, and/or receives program information as to the performers and genre from an external source so as to manage recording operations (automatic recording operation etc.) in response to desirable subjects of users.

In the method disclosed in JP-A-10-42234, the motion pictures can be managed which have been recorded as the entire motion picture functioning as a program having a certain time length. However, this server system does not intend to handle information of a highlight scene corresponding to a portion of this program. As a consequence, the user performs various operations (namely, fast-forward viewing operation, and rewind viewing operation) with respect to the motion pictures of the recorded program, and this user must search the highlight scene while confirming the pictures.

Even under such a condition that picture contents are digitally processed, highlight-scene information is mainly propagated by “word by mouth”, or by the oral instruction. As an example of this “word of mouth” communication method, a user talks with an acquaintance during meal time about “I enjoyed very much last scene of drama viewed at last night.” Also, a user talks with his friend over the telephone about “since fighting scene appears now in professional baseball game broadcasting program, please see it.”

Also, as communication methods other than the above-described “word by mouth” communication method, there are newspapers, WWW sites of the internet, or mail magazines with employment of electronic mails. These communication methods may sequentially introduce sports progress, and/or may introduce highlight scenes of topics.

In the conventional technique, the users must seek the relevant scenes contained in the motion pictures in such a manual manner based upon the “highlight” information which is actually seen/heard by the users themselves. Thus, the users are required to frequently perform such various operations as fast-forward reproducing operation and rewind reproducing operation. In addition, these users are forcibly required to see non-interest scenes, namely to spend waste time.

In particular, in such a case that the motion pictures stored in the motion picture storage server are viewed via the network by the portable viewing terminals, the works of the users make inconvenient in view of operability, in which the users seek the relevant scenes based upon the “highlight” information. Moreover, since the power consumption of the portable viewing terminals is increased, such works should be avoided as being permitted as possible.

In addition, under present conditions, the users select these motion pictures to be viewed, while these users see only titles and file names. As a result, there are some difficulties. That is, a user views such a motion picture which was viewed in the past while this user does not become aware of this past fact, and then becomes aware of such a face “this motion picture has been once viewed” in a half way, so that this user has a feeling of a waste of time.

Also, an increase of such a trend may be expected in near future that while users utilize a short free time outside their homes, these users view motion pictures on portable viewing terminals with having a sense of book reading. To realize such a viewing style of motion pictures, the following technical idea might be necessarily required. That is, for example, similar to bookmarks used when books are read, users may readily view the motion pictures from a picture portion “continued from preceding time.”

As the technique capable of preventing repetitive viewing of such a motion picture which has already been viewed, for example, a patent publication 1 has proposed the below-mentioned technical idea. In accordance with the technical idea described in JP-A-9-270006, when a motion picture is viewed, this motion picture is firstly analyzed so as to acquire feature amounts. These feature amounts are sequentially stored in a database. Then, a feature amount which was acquired in the past is compared with a feature amount of a motion picture which is presently viewed in order to continuously check as to whether or not the motion picture under observation corresponds to such a motion picture which has already been viewed. In the case that the presently-viewed motion picture is judged as the past-viewed motion picture, the reproducing operation of this presently-viewed motion picture is stopped.

However, the above-described technical idea of JP-A-9-270006 is intended to perform the judgment in real time while the motion picture is reproduced. This technical idea is not intended to judge as to whether or not the relevant motion picture has already been viewed before the user starts to view this motion picture. Further, although the technical idea of JP-A-9-270006 can grasp as to whether or not the relevant motion picture was viewed in the past, this technical idea cannot grasp how the relevant motion picture was viewed in the past.

As a consequence, with respect to such a viewing method as, for instance, “view motion picture from continued picture portion in preceding time”, and “view the same scene as that in preceding time”, users are required to perform fast-forward reproducing operations and/or rewind reproducing operations while these users must confirm memorized facts.

### SUMMARY OF THE INVENTION

The invention provides a motion picture storage apparatus, including: a motion picture input unit which inputs motion picture data; a motion picture storage unit which sequentially stores the motion picture data; a condition storage unit which stores a condition related to a desirable scene previously set by a user; a motion picture analyzing unit configured to analyze the motion picture data stored in the motion picture storage unit to check whether a scene satisfying the condition is present, and configured to acquire specifying information of the scene satisfying the condition when the scene satisfying the condition is present; and an information notifying unit which notifies the specifying information to a device of the user.

The invention may provide a motion picture storage apparatus including: a motion picture input unit which inputs motion picture data including at least one of a motion picture, coded data of the motion picture, and coded data of metadata containing the motion picture; a motion picture storage unit which sequentially stores the motion picture data; a condition storage unit which stores a condition related to a desirable scene previously set by a user; a motion picture analyzing unit configured to analyze the motion picture data stored in the motion picture storage unit to check whether a scene satisfying the condition is present, and configured to acquire specifying information of the scene satisfying the condition when the scene satisfying the condition is present; and a motion picture output unit which outputs to a device of the user motion picture data of the scene designated by the specifying information when the scene satisfying the condition is contained in the motion picture data analyzed by the motion picture analyzing unit.

The invention may provide a motion picture storage apparatus, including: a motion picture input unit which inputs motion picture data; a motion picture storage unit which sequentially stores the motion picture data; a specifying information receiving unit which receives specifying information for designating a specific scene of a motion picture; a motion picture analyzing unit which analyzes the motion picture data stored in the motion picture storage unit to check whether a scene corresponding to the specifying information is present; and an information notifying unit which notifies to a device of a user the fact that the scene corresponding to the specifying information is present when the scene corresponding to the specifying information is present.

The invention may provide a motion picture storage apparatus, including: a motion picture input unit which inputs motion picture data including one of a motion picture, coded data of the motion picture, and coded data of metadata containing the motion picture; a motion picture storage unit which sequentially stores the motion picture data; a specifying information receiving unit which receives specifying information for designating a specific scene of a motion picture; a motion picture analyzing unit which analyzes the motion picture data stored in the motion picture storage unit to check whether a scene corresponding to the specifying information is present; and an information notifying unit which notifies the specifying information to a device of a user when the scene corresponding to the specifying information is present.

The invention may provide a motion picture storage apparatus, including: a motion picture input unit which inputs motion picture data including one of a motion picture, coded data of the motion picture, and coded data of metadata containing the motion picture; a motion picture storage unit which sequentially stores the motion picture data; a specifying information receiving unit which receives specifying information for designating a specific scene of a motion picture; a motion picture analyzing unit which analyzes the motion picture data stored in the motion picture storage unit to check whether a scene corresponding to the specifying information is present; and a motion picture transmitting unit which transmits to a device of the user motion picture data of the scene corresponding to the specifying information when the scene corresponding to the specifying information is present.

The invention may provide a motion picture storage apparatus for storing motion picture data to provide the motion picture data to a reproducing device of a user, including: a storage unit which stores first coded data of a first coding system; a request accepting unit which receives a motion picture data sending request and a motion picture list sending request from the user; a viewing history producing unit which produces a viewing history from the motion picture data sending request; a converting unit which converts the first coded data stored in the storage unit into second coded data of a second coding system in response to the motion picture data sending request; an output unit which outputs the second coded data to the reproducing device; and a viewing history output unit which outputs the viewing history to the reproducing device in response to the motion picture list sending request.

The invention may provide a motion picture storage apparatus for storing motion picture data to provide the motion picture data to a reproducing device of a user, including: a storage unit which stores first coded data of a first coding system; a request accepting unit which receives a motion picture data sending request and a motion picture list sending request from the user; a viewing history producing unit which produces a viewing history from the motion picture data sending request; a converting unit which converts the first coded data stored in the storage unit into second coded data of a second coding system in response to the motion picture data sending request; an output unit which outputs the second coded data to the reproducing device; a specifying information producing unit which produces specifying information indicative of a specific portion of a motion picture from the viewing history; and a specifying information output unit which outputs the specifying information to the reproducing device according to the motion picture list sending request.

The invention may provide a motion picture providing method for providing motion picture data to a reproducing device according to a motion picture data sending request transmitted by a user, including: generating a viewing history on the basis of the motion picture data sending request; receiving a motion picture list sending request from the user; outputting the viewing history in a form selectable by the user; and providing the motion picture data to the reproducing device according to a selection by the user from the viewing history.

The invention may provide a motion picture providing method for providing motion picture data to a reproducing device according to a motion picture data sending request transmitted by a user, including: generating a viewing history on the basis of the motion picture data sending request; generating a specifying information for designating a specific motion picture; receiving a motion picture list sending request from the user; outputting the viewing history in a form selectable by the user; and providing the motion picture data of the specific motion picture to the reproducing device according to a selection by the user from the viewing history.

The invention may provide a viewing history investigating system, including: a distribution server which distributes motion picture data by the use of broadcasting or communication; a storage server which receives the motion picture data distributed from the distribution server and stores the received motion picture data; a reproducing device which acquires the motion picture data from the storage server so as to reproduce the acquired motion picture data; and an information collecting device; wherein the distribution server, the information collecting device, the storage server, and the reproducing device are connected with each other; and the storage server receives a request of the reproducing device, converts a coding system of the stored motion picture data, transmits the code-converted motion picture data, and produces a viewing history according to the request of the reproducing device to store the produced viewing history; and the storage server transmits the viewing history to the information collecting device on receiving a transmission request of the viewing history from the information collecting device.

The invention may provide a motion picture outputting apparatus, including: a request accepting unit which receives motion picture data sending requests and motion picture list sending requests sent from a plurality of users; a viewing history producing unit which produces a plurality of viewing histories of the plurality of users from the motion picture data sending requests; a specifying information producing unit which produces specifying information indicative of a specific portion of a motion picture from the plurality of viewing histories; an output unit which outputs motion picture data to a reproducing device; and a specifying information output unit which outputs the specifying information to the reproducing device according to the motion picture list sending request.

### BRIEF DESCRIPTION OF THE DRAWINGS

The present invention may be more readily described with reference to the accompanying drawings:

FIG. 1 is an explanatory diagram for explaining an arrangement of a motion picture storage apparatus according to Embodiment 1 of the present invention.

FIG. 2 is an image diagram for explaining a scene in which the motion picture storage apparatus according to a first embodiment of the present invention is employed.

FIG. 3 is an explanatory diagram for explaining an arrangement of a motion picture storage apparatus according to Embodiment 2 of the present invention.

FIG. 4 is an image diagram for explaining a scene in which the motion picture storage apparatus according to Embodiment 2 of the present invention is employed.

FIG. 5 is an explanatory diagram for explaining an arrangement of a motion picture storage apparatus according to a modification of the Embodiment 1 of the present invention.

FIG. 6 is a diagram illustratively showing a plurality of specifying information according to another modification of the motion picture storage apparatus.

FIG. 7 is a graphic representation for representing reproducing histories of the modification shown in FIG. 6.

FIG. 8 is a block diagram for indicating an arrangement of a motion picture storage apparatus according to Embodiment 3 of the present invention.

FIG. 9 is a diagram for explaining a system using the motion picture storage apparatus according to a second embodiment of the present invention.

FIG. 10 is a diagram for illustratively showing an operation screen used to select a motion picture which is viewed by a user on a portable viewing terminal.

FIG. 11 is a flow chart for sectioning a viewing history.

FIG. 12 is a diagram for illustratively indicating an operation screen used to select a viewing method by a user on a portable viewing terminal.

FIG. 13 is a diagram for explaining a system using a modification of the motion picture apparatus according to the Embodiment 3 of the present invention.

FIG. 14 is a diagram for explaining an arrangement of a modification as to the motion picture storage apparatus according to the Embodiment 3 of the present invention.

### DETAILED DESCRIPTION OF THE PREFERRED EMBODIMENTS

First Embodiment

(Outline)

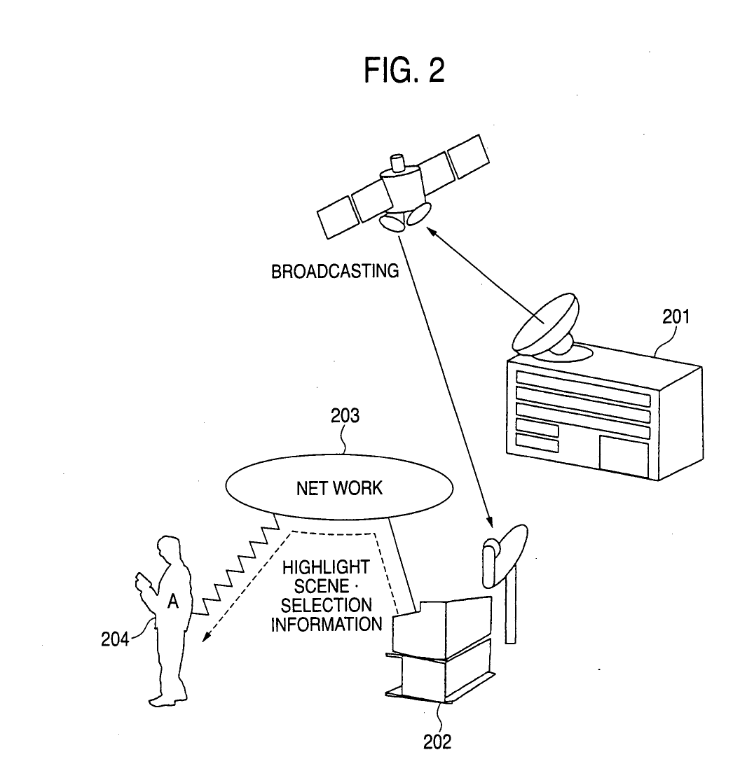

FIG. 2 is an explanatory diagram for explaining an example of a system with employment of a motion picture storage apparatus 202 according to a first embodiment of the present invention.

This motion picture storage apparatus 202 receives and stores MPEG-2-coded motion picture data that is provided by a contents service provider (CSP) 201 by way of a broadcasting method, or a communication method. Then, the motion picture storage apparatus 202 transmits the stored motion picture data to a user's viewing device 204 via a network 203, in response to a request of this user.

The motion picture storage apparatus 202 receives and stores MPEG-2-coded motion picture data that is provided by a contents service provider (CSP) 201 by way of a broadcasting method, or a communication method. Then, the motion picture storage apparatus 202 converts the stored motion picture data into MPEG-4-coded data, and transmits the converted motion picture data to a user's viewing device 204, in response to a request of this user.

Furthermore, the motion picture storage apparatus 202 receives and analyzes motion picture data so as to find out the scenes that are interesting to the user, according to the condition which is predefined by the user. Then, when a interesting scene is found, this motion picture storage apparatus 202 transmits specifying information to a user's viewing device 204 via a network 203. This specifying information may contain, for example, a file name of motion picture data, time pointers or frame numbers in a motion picture, or regional information in a frame. And this specifying information is employed to access specific interesting scenes or specific interesting objects in the motion picture data. It should be noted that the above-explained network can be either a wired, or a wireless network.

For example, the motion picture storage apparatus 202 is installed in a user's home, and the user with the portable viewing device 204 is away from his home. Even in such case, as the interesting scene is stored in the motion picture storage apparatus 202, a notification is sent to the portable viewing device 204 from this motion picture storage apparatus 202. The user can easily and directly view the interesting scenes by using the specifying information that is carried in the notification, even when he is away from home.

Also, such a notification can be sent to an ordinary portable device (for example, cellular phone or portable personal computer) by way of an electronic mail (e-mail). As the result, the motion picture storage apparatus 202 may issue the notification to the user even when the portable viewing device 204 is not ready to receive the notification. The user can manually operate the portable viewing device 204 when it is ready to receive, and can easily and directly view the interesting scenes.

The user receives the above-described “specifying information” on the portable viewing device 204. The specifying information is sent to the user from the motion picture storage apparatus 202 via the network 203. Then, since the user employs this “specifying information”, the user can easily and directly view the interesting scenes and listen to sounds of the scenes on the portable viewing device 204.

(Embodiment 1)

Referring now to drawings, a motion picture storage apparatus according to Embodiment 1 of the present invention will be described.

(Schematic Structure)

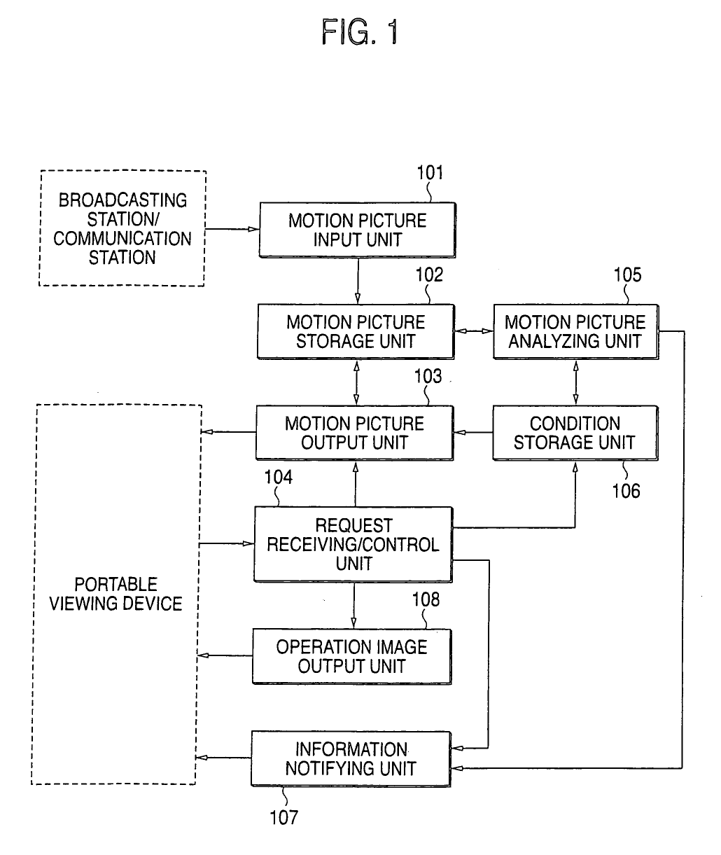

FIG. 1 is a block diagram for schematically indicating a structure of the motion picture storage apparatus according to this Embodiment 1.

The motion picture storage apparatus, according to the first embodiment, is provided with a motion picture input unit 101, a motion picture storage unit 102, a motion picture output unit 103, a request receiving/handling unit 104, and an operation screen output unit 108. The motion picture input unit 101 received coded data of a motion picture from an external source, or inputs thereinto coded data of a motion picture by way of an arbitrary method. The motion picture storage unit 102 stores thereinto either the received motion picture coded data or the inputted motion picture coded data. The motion picture output unit 103 outputs the coded motion picture data in response to a request issued from the user. The request receiving/handling unit 104 handles the user's request, and controls the motion picture data, in response to a request by receiving this request from the user. The operation screen output unit 108 outputs an operation screen which is used when the user send the request.

This motion picture storage apparatus is further equipped with a motion picture analyzing unit 105, a condition storage unit 106, and an information notifying unit 107. The motion picture analyzing unit 105 analyzes the coded data of the motion picture which has been stored in this motion picture storage apparatus, and thus searches scenes in which the user has a great interest. The condition storage unit 106 stores thereinto “conditions” that are used to search such scenes in which the user has a great interest. The information notifying unit 107 notifies “specifying information” to the user's portable viewing device (refer to FIG. 2) in such case that the interesting scene is found out, while this “specifying information” is related to this scene.

(Schematic Operation)

A basic operation of the motion picture storage apparatus according to this first embodiment will now be described. First, coded data of a motion picture such as a broadcasting program which is transmitted from either a broadcasting station (wired/wireless manners) or a network is received by the motion picture input unit 101, and then, the received motion picture coded data is stored in the motion picture storage unit 102. It is so assumed that the coded data of the motion picture which is received by this motion picture storage apparatus has been coded by way of the MPEG (Motion Picture Experts Group)-2 system.

The motion picture analyzing unit 105 searches such interesting scenes in the motion picture data stored in the motion picture storage unit 102 in accordance with the “conditions” which have been predefined by the user and stored in the condition storage unit 106. Then, when the interesting scene can be found out, the motion picture analyzing unit 105 notifies “specifying information” related to this interesting scene via the information notifying unit 107 to the user's portable viewing device.

The request receiving/handling unit 104 accepts various requests issued from the user. These various requests correspond to, for example, a request for defining/deleting/editing the above-explained “conditions”, a scheduling of recording operation, a transmission of a recorded motion picture to a portable viewing device, a partial playing operation using the above-explained “specifying information”. In response to a request made by the user, the request receiving/handling unit 104 commences the transmission to the motion picture output unit 103, and/or updates “conditions” stored in the condition storage unit 106.

The request receiving/handling unit 104 also provides necessary information for the operation screen output unit 108 to produce a GUI (Graphical User Interface) on which the user inputs the request.

The motion picture output unit 103 transmits the coded data of motion picture to the user's portable viewing device in response to the request of the user which is received by the request receiving/handling unit 104. While this motion picture output unit 103 is equipped with a coding format converting (=in other word, transcoding) function, the motion picture output unit 103 reads out the MPEG-2-coded motion picture data stored in the motion picture storage unit 102, and then converts this motion picture coded data into such a motion picture data coded by the MPEG-4 system, and transmits this MPEG-4-coded motion picture data.

It should be understood that his motion picture storage apparatus is made of the following assumption. That is, motion picture data coded by the MPEG-2 system is received/stored, and then is converted (transcoded) into the motion picture data coded by the MPEG-4 system so as to transmit this motion picture data coded by the MPEG-4 system in this motion picture storage apparatus. However, the present invention is not limited only to this combination of these coding systems. For instance the present invention may alternatively employ any coding systems including the MPEG-1 system.

For instance, the motion picture storage apparatus of this first embodiment may receive/store motion picture data coded by the MPEG-1 system, and then, may convert (transcode) this MPEG-1-coded motion picture data into such an MPEG-4-coded motion picture data so as to be transmitted. In other case, the motion picture in analog signal may be inputted into this motion picture storage apparatus, and the motion picture input unit 101 may encode the inputted motion picture data into MPEG-2 format, and then the inputted, encoded, and stored motion picture data may be converted into MPEG-4 format and transmitted.

Also, either a motion picture data or coded data, which are received, may have been encrypted (scrambled). In this alternative case, after these encrypted picture/data are decrypted in the motion picture input unit 101, these decrypted picture/data may be alternatively stored in the motion picture storage apparatus.

Alternatively, for example, in such a case that both this motion picture storage apparatus and the portable viewing device are installed within a home are connected to each other via a high-speed network, motion picture data in MPEG-2 format may be directly transmitted to the portable viewing device without any transcoding, so that pictures having high image qualities may be alternatively viewed. Otherwise, such a motion picture which has been decoded in the motion picture output unit 103 maybe transmitted. Whether or not the data should be transcoded, or into which bit rate the data should be transcoded, may be decided either by the user manually, by this motion picture storage apparatus automatically, or by the portable viewing device automatically, according to the capability of the viewing device or of the network.

(Motion Picture Input Unit 101)

The motion picture input unit 101 receives the MPEG-2-coded motion picture data, which has been transmitted from the broadcasting station, or the communication station. Then the motion picture input unit 101 sequentially outputs the received coded data to the motion picture storage unit 102.

As to coded data which is entered into the motion picture input unit 101, such coded data may be employed which have been stored in hard disks, optical disks, or semiconductor memory devices as an electronic file. Alternatively, such coded data may be similarly employed which are transmitted by way of a streaming distribution, a digital broadcasting system, an e-mail, or by using electromagnetic transmission.

(Motion Picture Storate Unit 102)

The motion picture storage unit 102 corresponds to a storage apparatus for storing thereinto the MPEG-2-coded data, such as a hard disk drive, an optical disk drive, and a semiconductor memory device.

The MPEG-2-coded data which has been received by the motion picture storage unit 102 is stored in this storage apparatus.

It should also be noted that when a audio-visual program is provided in the form of such a recording medium containing an optical disk, a semiconductor memory device, or a hard disk, the content (program) of this recording medium may be read by the motion picture input unit 101 and then this read content may be copied in the motion picture storage unit 102. Alternatively, the recording medium it self may be utilized as the motion picture storage unit 102.

(Motion Picture Output Unit 103)

The motion picture output unit 103 converts (transcodes) the MPEG-2-coded data which has been stored in the motion picture storage unit 102 into MPEG-4-coded data (namely, motion picture data which has been coded by MPEG-4 system), and then transmits this MPEG-4-coded data to the user's portable viewing device in response to the request of the user received by the request receiving/handling unit 104.

In such case that the request sent from the user contains the above-described “specifying information”, the motion picture output unit 103 extracts data portions specified by the “specifying information” from the MPEG-2-coded data. Which has been stored in the motion picture storage unit 102, and then transcodes this extracted portions into the MPEG-4-coded data.

The motion picture output unit 103 is provided with a searching unit, a transcoder (coding format converter), and a transmitting unit. The searching unit searches data requested by the user from the MPEG-2-coded data which has been stored in the motion picture storage unit 102. The transcoder converts the MPEG-2-coded data into the MPEG-4-coded data. The transmitting unit transmits the MPEG-4-coded data which has been converted to be obtained to the user's portable viewing device.

(Request Receiving/Handling Unit 104)

The request receiving/handling unit 104 provides necessary information for the operation screen output unit 108 to produce a GUI on which the user inputs the request. Then, this request receiving/handling unit 104 receives various requests issued from the user which is entered vie the GUI. Then, in response to the request of the user, the request receiving/handling unit 104 may cause the moving picture output unit 103 to transmit, and may update the conditions stored in the condition storage unit 105.

It should also be noted that the above-explained “request” corresponds to, for instance, such a request to define/delete/edit the above-explained “conditions”, a scheduling of recording operation, a request for transmitting a recorded motion picture to a portable viewing device, a request to transmit with employment of the above-described “specifying information”, and setting of destination of a notification.

(Operation Screen Output Unit 108)

The operation screen output unit 108 produces the GUI in response to the request of the request receiving/handling unit 104, and then outputs this produced GUI to the portable viewing device.

(Condition Storage Unit 106)

The condition storage unit 106 stores thereinto a “conditions” of interesting scenes, which have been registered by the user in advance. The condition storage unit 106 is equipped with a hard disk, an have stored the “conditions” in the hard disk. It should also be noted that the medium for storing thereinto the conditions may be realized by an optical disk, or a semiconductor memory device other than the hard disk.

The “conditions” of the interesting scenes correspond to various sorts of information, for example, names and face images of interesting persons on TV, important keywords of news topics, words, captions, speech which are related to featured events such as “goal” and “home run”.

(Motion Picture Analyzing Unit 105)

The motion picture analyzing unit 105 performs both image and audio analyzing operations by employing “conditions” stored in the condition storage unit 106 with respect to both an image and audio, which are obtained by decoding the coded data stored in the motion picture storage unit 102. It should be understood that the analyzing operation may be carried out while this motion picture storage apparatus is storing.

Then, when there is such a scene which is matched with the “conditions” stored in the condition storage unit 106, the motion picture analyzing unit 105 outputs both “specifying information” and such a fact that interesting scene is recorded (otherwise has been recorded) to the information notifying unit 107. This “specifying information” contains such information related to a record file name, and a position thereof within a file of the relevant scene.

When the motion picture analyzing unit 105 analyzes image, for example, the motion picture analyzing unit 105 analyzes a caption contained in the image, or recognizes face images so that specific words or persons appear in the image. When audio is analyzed, the motion picture analyzing unit 105 analyzes contents of a scene by detecting or recognizing voice of a specific actor/actress, or a cheer. Alternatively, the motion picture analyzing unit 105 detects a performer appeared in this scene by recognizing a specific music for the performer.

For example, assuming now a home run scene of baseball program, a motion picture may probably contain a shout “home run” of an announcer, a caption for indicating that the team has got a score, a cheer in the stadium, and so on. Also, for instance, assuming now a music show, a motion picture may probably contain a face image of a specific singer, title of the music sung by the singer, a caption of the singer at her appearing scene, and the like.

In order to specify a scene from audio, speech recognition may be usefully employed. As one example of the speech recognition, a method called as “word-spotting” may be considered. When this “word-spotting” method is employed, words talked by an actor/actress are converted into text data, an analysis is done as to whether or not a keyword designated by a user is matched with this text data, so that a scene of interest may be specified.

As to the above-described “conditions”, for example, in the case that an MVP interview of a player A is designated in baseball game broadcasting, such conditions are designated as follows: [November 11: 9:20 pm to 10:00 pm EST: baseball game: player A/MVP interview: before/after 3 minutes]. In this case, the motion picture analyzing unit 105 analyzes the scene based upon voice of an announcer, namely [player A], and [MVP interview], and a caption indicated on a screen.

Otherwise, if a scene of player A at bat is designated, then the following conditions are designated, namely, [November 11: 9:20 pm to 10:00 pm EST: baseball game: player A at bat: before/after 3 minutes: (additional identifier of face image data of player A)]. In this case, the motion picture analyzing unit 105 analyzes the scene by employing the face image of the player A in addition to a caption and voice.

When the motion picture analyzing unit 105 analyzes image and audio according to the conditions of the interesting scenes, and when a scene that follow the conditions can be extracted, then the motion picture analyzing unit 105 determines that the scene matches the conditions. It should be noted that when a frequency degree (for example, 5 or more times per a minute) of the above-described match is also considered during determining operation, it is possible to avoid an erroneous determination.

In this motion picture storage apparatus, the MPEG-2-coded data is received to be stored, and both video and audio are analyzed. Alternatively, in such a case that, for instance, description information (metadata) of contents in MPEG-7 format is received, a text matching operation may be carried out with respect to the metadata of the MPEG-7 system so as to determines as to whether or not this metadata is matched with “conditions”. In this alternative case, keywords may be described in the above-described “conditions”, while these keywords are to retrieve by using the metadata by the MPEG-7 system.

While the present invention is not limited to the MPEG-7-coded data, if data coded by a coding system including such a metadata is available, then such a coded data may be employed as clues for determining as to whether or not this coded data is matched with “conditions”.

Even when such a metadata is not contained in coded program data itself, even in such a case that metadata is distributed over a different means from a broadcasting station or a communication station, this distributed metadata may be employed as clues for determining as to whether or not the motion picture is matched with “conditions”.

Also, “specifying information” maybe made of such a data having an allowable range, for example, “before/after 1 minute at time when it is so determined that being matched with conditions”. If so, then such a suddenly occurring scene as a home run may be captured without missing a highlight scene.

(Information Notifying Unit 107)

The information notifying unit 107 receives such a notification that a interesting scene has been recorded from the motion picture analyzing unit 106, and then notifies such an information which contains “specifying information” related to this scene to the user. A notification destination corresponds to the device which is set by the user by operating the request receiving/handling unit 104, and an e-mail is employed as a notifying means.

A content of this notification corresponds to such a message that the interesting scene has been recorded, and also, information indicative of a recorded file name, and a position within a file of this relevant scene.

It should also be noted that the notifying means is not limited to an e-mail. More specifically, in the case that a notification is sent to a terminal with small screen or with lower computational resources (for example, a portable viewing device), instead of such an e-mail, it is better that this notification may be displayed on the operating GUI via the operation screen output unit 108.

(Use Example of Motion Picture Storage Apparatus)

For instance, even in such a case that the motion picture storage apparatus according to this first embodiment is installed in the user's own home, and this user with the portable viewing device is away from his home, if the interesting scene is stored in this motion picture storage apparatus, then the notification is issued to the portable viewing device. Then, the user sends the request for the motion picture storage apparatus to transmit the motion picture data, while this user utilizes “specifying information” contained in the notification. As a result, the user can easily and directly view the interesting scenes even when he is away from home.

Also, such a notification can be sent to an ordinary portable device (for example, cellular phone or portable personal computer) byway of an e-mail. As the result, the motion picture storage apparatus may issue the notification to the user even when the portable viewing device is not ready to receive the notification. The user can manually operate the portable viewing device when it is ready to receive, and can easily and directly view the interesting scenes.

(Modifications)

In this embodiment, when the interesting scene is once recorded, both the message of this recording operation and “specifying information” are notified. Alternatively, both the message and the coded data as to this scene may be transmitted from the motion picture output unit 103 to the user's portable viewing device.

Alternatively, at this time, the image of this relevant scene may be modified. For instance, the user previously sets [when player hits a home-run, image area constructed of 120 pixels×160 pixels around player A is outputted]. Then, when [player A hits a home-run] is recorded, an image modification may be carried out in accordance with the modification condition(s) of [image area constructed of 120 pixels×160 pixels around player A is outputted], and then, the modified image area is transmitted to the user's portable viewing device.

In such a case that spatio-temporal information as to an object is contained in either coded data of a motion picture inputted into this motion picture storage apparatus or metadata which is distributed in combination with this motion picture coded data, the above-explained modification may be carried out by utilizing this spatio-temporal information (namely, information for indicating that which object is present at which position within which frame).

Also, in this first embodiment, the format of the motion picture data distributed from the broadcasting station, or the communication station is selected to be the MPEG-2 coding system, but the present invention is not limited thereto. For instance, even when motion picture data coded by either the MPEG-4 system or the MPEG-7 description is distributed from the broadcasting station, or the communication station, the present invention may be applied thereto. This modification may be similarly applied to the data output to the portable viewing device. In this first embodiment, the data coded in the MPEG-4 system is outputted, but the present invention is not limited thereto. That is, either MPEG-2-coded data or MPEG-1-coded data may be outputted. Alternatively, other motion picture coding systems may be employed.

Also, the “specifying information” is transmitted to the user's portable viewing device in this first embodiment. Alternatively, an identifier corresponding to “specifying information” may be allocated by the motion picture storage apparatus. This identifier may be stored on the motion picture storage apparatus and may be transmitted to the user's portable viewing device.

In this alternative case, the motion picture storage apparatus may be arranged in such a manner that the scenes indicated by “specifying information” have been extracted, transcoded, and modified in advance to the user's request. As previously explained, since the extraction, transcoding, and modification have been completed, the motion picture data may be quickly transmitted when the request to acquire the motion picture of this scene is issued from the user, and also, the loads given to this motion picture storage apparatus may be smoothed because such operations as extraction, transcoding, and modification can be done whenever the apparatus is ready to perform those operations.

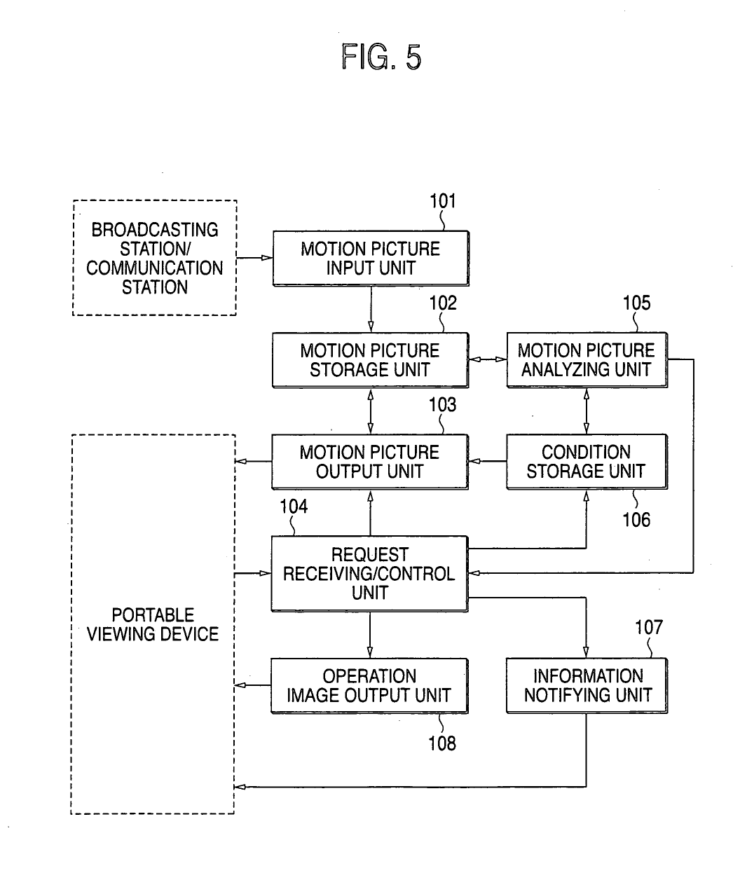

FIG. 5 is a block diagram for indicating a better-designed arrangement of a motion picture storage apparatus according to the present invention, capable of realizing these modifications. That is, a different structure of this motion picture storage apparatus with respect to that of the fist embodiment is given as follows: An output from the motion picture analyzing unit 105 is entered via the request receiving/handling unit 104 to the motion picture output unit 103. With employment of this modified arrangement, such a process operation may be easily carried out in which the notification is sent to the user, and at the same time, the motion picture data is transmitted.

(Effects of Embodiment 1)

As previously described, in the motion picture storage apparatus of this Embodiment 1, in such a case that the coded data of the moving image is received which contains the content of the scene which has been previously designated by the user, this coded data is notified to the user.

As a result, the user can readily view his scene.

(Embodiment 2)

Referring now to drawings, a motion picture storage apparatus according to a second embodiment of the present invention will be described.

(Outline of Second Motion Picture Storage Appratus)

FIG. 2 is an explanatory diagram for explaining example of a system using this motion picture storage apparatus.

This motion picture storage apparatus receives and stores MPEG-2-coded motion picture that is provided by a contents service provide (CSP) 201 by way of a broadcasting method, or a communication method, Then, this motion picture storage apparatus 202 converts (transcodes) the MPEG-2-coded data into MPEG-4-coded data and then transmits this MPEG-4-coded data to a portable viewing device 204 in response to a request of a user.

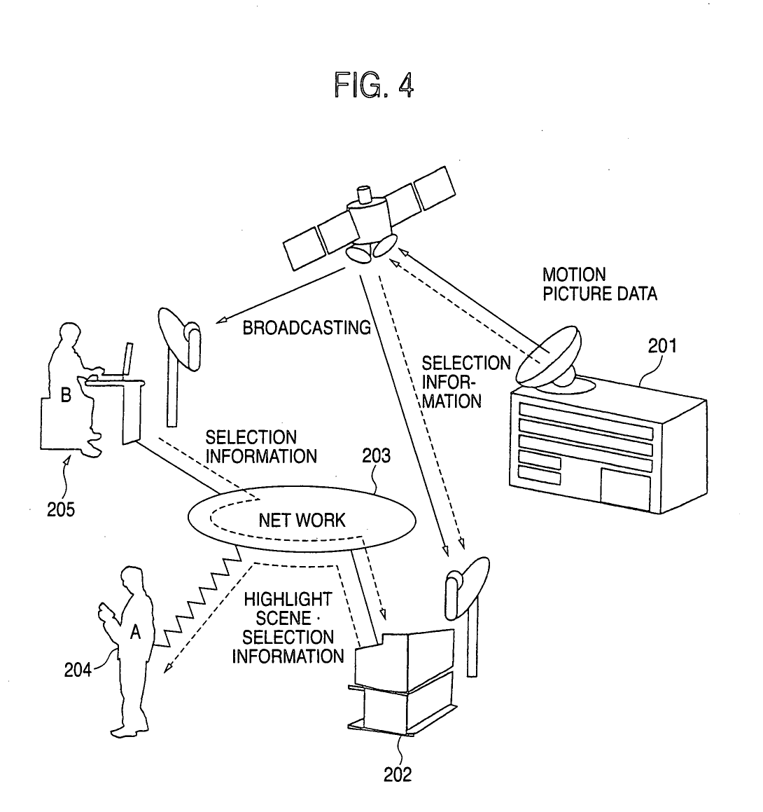

Also, this motion picture storage apparatus acquires “specifying information” from an external source (specifying information producer B205 in FIG. 4), and in such a case that coded data of a motion picture indicated by this “specifying information” has been stored, this motion picture storage apparatus notifies to the user that the motion picture data corresponding to the specifying information has been stored in this motion picture storage apparatus.

It should be noted that the specifying information produce B250 may also be identical to the CSP 201. For instance, when either a broadcasting station or the CSP 201 transmits “specifying information” related to a highlight scene in addition to motion picture information of a broadcasting program, this “specifying information” is notified from this motion picture storage apparatus to the user, and thus, the user can readily view the highlight scene by utilizing the notified “specifying information”.

Also, for example, when either a friend or an acquaintance provides “specifying information” related to an amusing scene of a certain program with respect to this motion picture storage apparatus, if the relevant program has been recorded (or being recorded) in this motion picture storage apparatus, then “specifying information” of the amusing scene recommended by the friend or the acquaintance is notified to the user from the motion picture storage apparatus. Then, the user can readily view the amusing scene recommended by the friend, or the acquaintance by utilizing this “specifying information”.

It should be understood that the MPEG-2-coded data has been received in the above-described explanation. However, the present invention is not limited only to this example. That is, the motion picture storage apparatus of the second embodiment may be alternatively arranged in such a way that MPEG-1-coded data, MPEG-2-coded data, or data coded by any motion picture coding systems other than MPEG systems may be received to be stored.

(Schematic Arrangement/Operations)

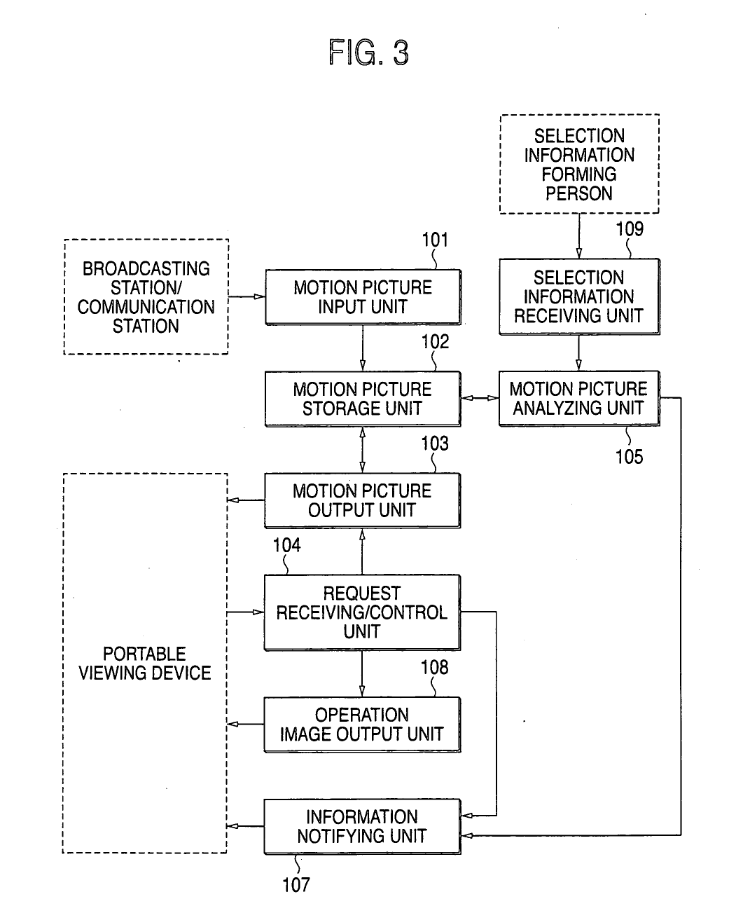

FIG. 3 is a diagram for schematically explaining an arrangement of the motion picture storage apparatus according to this Embodiment 2. Since the arrangement of this motion picture storage apparatus according to Embodiment is similar to that of Embodiment 1, a different arrangement is mainly described.

Different from the motion picture storage apparatus of the first embodiment, this motion picture storage apparatus does not search interesting scenes for the user. As a consequence, this motion picture storage apparatus does not own such a unit corresponding to the condition storage unit 106 of FIG. 1.

On the other hand, the motion picture storage apparatus of this second embodiment is equipped with a specifying information receiving unit 109 which receives “specifying information” from external sources, and outputs this received “specifying information” to the motion picture analyzing unit 105.

A motion picture analyzing unit 105 of this motion picture storage apparatus checks as to whether or not a motion picture indicated by “specifying information” has been stored in a motion picture storage unit 102. Then, in the case that this motion picture has been stored in the motion picture storage unit 102, this fact is notified via an information notifying unit 107 to the user.

For the sake of a simple explanation, this motion picture storage apparatus owns no such a unit corresponding to the condition storage unit 106. Alternatively, while the unit corresponding to the condition storage unit 106 is provided, the motion picture storage apparatus of this second embodiment may be equipped with a function equivalent to the motion picture storage apparatus of the first embodiment.

(Specifying Information Receiving Unit 109)

The specifying information receiving unit 109 receives “specifying information” which is supplied by a broadcasting manner, or via the Internet. Then, the specifying information receiving unit 109 outputs the received “specifying information” to the motion picture analyzing unit 105.

The “specifying information” is transmitted as a portion of broadcast data from a broadcasting station. Otherwise, the “specifying information” is transmitted from a third party (for example, friend, acquaintance, or information service provider (ISP)) via the Internet similar to such a data attached to an e-mail.

In this case, “specifying information” to be received implies such an information which contain an identifier specific to a motion picture content, and information includes temporal information and spatial information, while the temporal information is such an information indicative of a temporal portion of a motion picture, and the spatial information is such an information indicative of spatial portion of this motion picture.

The temporal information corresponds to, for example, either a range of frame numbers (from 1580th frame up to 1692nd frame) of a motion picture or a range of presentation time (4 minutes 11 seconds from start until 4 minutes 32 seconds have passed from start).

Also, the spatial information corresponds to, for example, an object number (object ID=1234), or coordinate values of an object area (namely, area surrounded by (10,12)-(212,20)-(362,32)- . . . -(32,60)-(10,12)). It should be understood that in the case that coded data of the MPEG-4 system is distributed from a broadcasting station, or a communication station, an ID which indicates a video object in the MPEG-4-coded data also be utilized as the spatial information.

An identifier specific to a content corresponds to a file name, an ID of an optical disk, either a portion of coded data before decoding operation or a portion of coded data after decoding operation, a title name of a content. In the case that metadata in the MPEG-7-coded data is distributed from a broadcasting station, or a communication station, this metadata in the MPEG-7-coded data may be utilized as an identifier specific to the content.

The specifying information receiving unit 109 receives “specifying information” which contains the above-explained content from the external source. As a format of this “specifying information” transmitted from the external sources, such various system formats known as XML, MPEG-7, and MPEG-4 may be realistically used, but this second embodiment does not make any limitation in the format.

It should be noted that “specifying information” may be supplied via such a recording medium as an optical disk and a semiconductor memory device. In this case, the specifying information receiving unit 109 reads out “specifying information” from these recording media, and then, outputs the read “specifying information” to the motion picture analyzing unit 105.

(Motion Picture Analyzing Unit 105)

The motion picture analyzing unit 105 extracts the information of the motion picture contents from the specifying information received from the specifying information receiving unit 109, and checks as to whether or not the relevant motion picture has been stored in the motion picture storage unit 102. When the relevant motion picture has been stored, the motion picture analyzing unit 105 notifies “specifying information” to the information notifying unit 107.

(Information Notifying Unit 107)

The information notifying unit 107 notifies “specifying information” received from the motion picture analyzing unit 105 to the user. The notification destination corresponds to a device which has been previously set by the user via the request receiving/handling unit 104, and an e-mail is employed as a notifying means.

It should also be noted that the notifying means is not limited to an e-mail. More specifically, in the case that a notification is sent to a terminal with small screen or with lower computational resources (for example, a portable viewing device), it is better to display this “specifying information” on the operating GUI via the operation screen output unit 108 instead of the e-mail so as to achieve user-friendly operation.

Also, the notification content is not limited to the above-described “specifying information”. For instance, such a simple notification “[specifying information] is received” maybe issued. Otherwise, motion picture data itself if a scene indicated by “specifying information” may be transmitted. Also, as previously explained in the modification of the first embodiment, while an identifier is allocated to “specifying information”, this identifier may be notified.

(Use Example of Picture Storage Apparatus of Second Embodiment)

Either a broadcast provider or a CSP sends out motion picture data by an ordinary method. As to such a data portion which is especially wanted to be highlighted (emphasized) by this provider in this motion picture data, this provider transmits “specifying information” for specifying this emphasized data portion to the motion picture storage apparatus by using its own transmitting means (i.e. broadcasting wave), the Internet, or any transmission means (i.e. e-mail, etc.)

This emphasized data portion corresponds to, for example, a time range (8:23:15 pm to 8:23:45 pm) of either a home run scene or a fine play scene happens to occur while a baseball game is broadcasted. It should also be noted that a specifying reason (leaping catch by player A) may be attached to the above-explained “specifying information”.

The motion picture storage apparatus receives the above-described “specifying information”, and notifies such a fact that a scene corresponding to “specifying information” has been stored thereinto to the user.

As a notification content notified to the user, for instance, such a content is conceivable, i.e., “leaping catch scene of player A has been recorded”. As a result, even when the user is out of his home, this user may receive this notification at a place outside his home, and after the user returns to his home, this user may enjoy to view this leaping catch scene.

(Modification 1)

It should also be understood that the motion picture data which can use “specifying information” in this motion picture storage apparatus is not limited only to such motion picture data which are distributed from the broadcasting station and the communication station. Alternatively, such motion picture data may be employed which have been recorded on recording media such as an optical disk and a semiconductor memory.

For instance, since such a “specifying information” as [scene defined from 22 minutes 15.0000 seconds up to 22 minutes 49.5000 seconds as to DVD tilted “Letter from XX”] is employed, the user may easily view a specific scene similar to the motion picture data distributed from the broadcasting station and the communication station.

(Modification 2)

In accordance with the above-described motion picture converting method of the present invention, the transmission of the specifying information is waited in the passive manner. Alternatively, every time a previously defined time has passed (for example, every 10 minutes), or at a preselected time instant, the specifying information receiving unit 109 may be operated automatically, so that this motion picture storage apparatus may try to acquire “specifying information” from an information providing place in a preset channel, or on the Internet.

Concretely speaking, in the case that the specifying information is provided as “highlight information” at a certain site on the Internet, the above-explained specifying information receiving unit 109 periodically checks the update at the site.

It should also be understood that a person who provides specifying information may be the same person who provides motion picture data (contents), and/or a third information providing person who is different from a user.

For example, it is so assumed that a person who loves a professional baseball team A provides specifying information providing service. By providing the above-described “specifying information”, he can provide “highlight” scenes in a professional baseball game broadcasting in his point of view.

In this case, the user of this motion picture storage apparatus may select such a specifying information provider whose favor is similar to this user, information of this specifying information providing source may be previously set to this motion picture storage apparatus. Similarly, if there is a third specifying information provide who provides highlight information specific to an actor/actress with respect to a certain drama broadcasting program, then the user merely selects such a specifying information provider having the same viewpoint as the own user, so that this user may receive digest information which is approximated to the own likes.

The above-explained example has been made as to such a case that the third information provider is a single person, and the specifying information provided by this third information provider is single specifying information. However, the present invention is not limited only this single person/information case.

In other words, a plurality of specifying information providing sources corresponding to the third information provider may employed. Otherwise, a single information providing person may provide a plurality of specifying information. Furthermore, a plurality of specifying information providing sources may provide a plurality of specifying information.

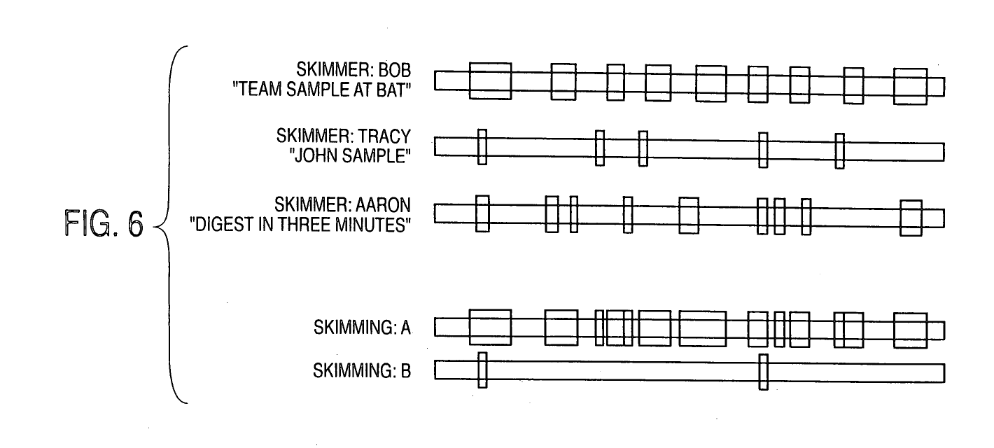

For instance, FIG. 6 illustratively shows several pieces of specifying information related to a baseball game broadcasting program, which are provided by three specifying information providing persons who are named BOB, TRACY, and AARON. In this drawing, laterally-elongated rectangular shapes indicate time progresses of the entire broadcasting program, whereas small-sized rectangular shapes attached to these laterally-elongated rectangular shapes represent sections of selecting information. BOB selects portions of Team Sample on offense as the specifying information, and TRACY selects scenes where a player “John Sample” is displayed as the specifying information. While AARON looks over the entire broadcasting program, AARON picks up highlights which constitute a digest scene in 3 minutes. The user may receive three different sorts of specifying information as explained above, and then may view the baseball broadcasting program by employing favorite specifying information selected from a list in which the selection ranges (see upper part of FIG. 6) of BOB, TRACY, AARON are indicated.

Also, as represented as “Skimming A” in a lower part of FIG. 6, new “specifying information” may be formed, and then, the user may view the broadcasting program by using this newly-formed “specifying information”, while this newly-formed “specifying information” is formed so that moments which belong to any one of the three time coverage are covered by the newly-formed “specifying information” (OR operation).

Furthermore, as represented as “Skimming B” in another lower part on FIG. 6, new “specifying information” may be formed, and then, the user may view the broadcasting program by using this newly-formed “specifying information”, while this newly-formed “specifying information” is formed so that moments which belong to all three time coverage are covered by the newly-formed “specifying information” (AND operation).

As apparently from the foregoing explanation, the method for forming the new “specifying information” is not limited to the above-described “forming method designated by any one of three providers”, but also not to limited to the above-described “forming method designated by all of the three providers”. Alternatively, such a time range which is designated by “any one of BOB and TRACY”, or another time range which is designated by “both TRACY and AARON” may be set as new “specifying information”.

In order that these plural pieces of new specifying information are synthesized with each other and any one of these plural pieces of specifying information is selected, a server capable of temporarily storing the plural sets of specifying information is required. This server may be realized by the above-explained motion picture storage apparatus 202 of FIG. 4, or by employing another storage-purpose server (not shown) which is connected to the network 203.

In this case, the motion picture storage apparatus 202 may alternatively synthesize the new specifying information with each other. Also, another storage-purpose server (not shown) which is connected to the network 203 may alternatively synthesize the new specifying information with each other.

On the other hand, as proposed in the Third Embodiment which will be explained later, the user may alternatively form the specifying information by employing the viewing history which has been produced while this user views the program by employing the motion picture storage apparatus of the present invention, and further, may control the showing operation by employing the viewing history. This example will be explained in the below-mentioned descriptions.

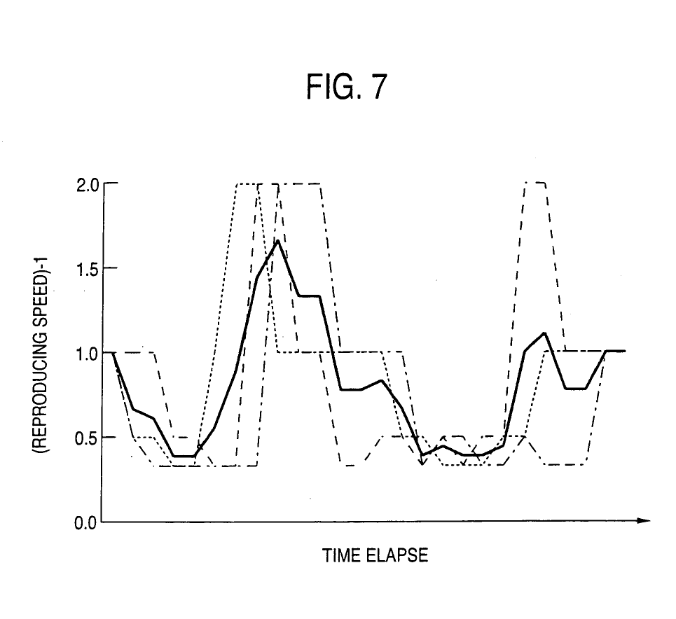

FIG. 7 is a graphic representation for showing viewing histories when a plurality of users view the same program. In this graphic representation, a broken line, a dotted line, and a dot/dash line indicate viewing histories when the different users view the same program. A thick line represents an average of the viewing histories as to three users. The horizontal axis indicates elapsed time within the program, and the vertical axis indicates reciprocal of viewing speed at which three users has viewed the program. For example, when a motion picture at a certain time instant is viewed at normal speed, a reciprocal of 1 (=1) is plotted; when a motion picture at a certain moment is fast-forwarded at a double speed, a reciprocal of 2 (=0.5) is plotted; and when a motion picture at a certain moment is played slowly at a half speed, a reciprocal of 0.5 (=2) is plotted. The view histories of the users as indicated by the broken line, the dotted line, and the dot/dash line of FIG. 7 have been stored in the motion picture storage apparatus 202, or the storage-purpose server (not shown) connected to the network 203 in accordance with the above-explained method.

Alternatively, when the motion picture storage apparatus according to the First Embodiment shows the motion picture, the showing operation of this motion picture may be controlled by employing such a highlight information which has been produced by employing the viewing histories of either the single person or the plural third parties with respect to the subject program. This showing controlling operation implies the following control operations: That is, for instance, only such a history portion that the viewing history indicated by the broken line exceeds 1 is shown as new “specifying information”. Also, as indicated by the thick line in FIG. 7, only such a history portion that the average value of the viewing histories as to three persons exceeds 1 is shown as new “specifying information”. Alternatively, the user himself may select the viewing history of the broken line, the viewing history of the dotted line, the viewing history of the dot/dash line, or the averaged viewing history thereof by way of such a method using the upper part of FIG. 6.

Further, when the new “specifying information” is produced from a plurality of viewing histories, while these viewing histories are not simply averaged, a statistical calculation may be carried out by that only a specific viewing history is weighted in response to an instruction of a user so as to own a large influence. While the respective viewing histories are employed, or the statistical synthesizing operation of the viewing histories are employed, the motion picture viewing speed with respect to the subject program of the motion picture storage apparatus according to the present invention may be controlled.

In the simplest method, a motion picture is shown at a similar showing speed to that for viewing history of a third party. In addition, the showing speed may be changed in accordance with the above-described statistical synthesizing operation (for example, averaging operation) of the viewing histories.

In other words, since the reciprocal of the thick line shown in FIG. 7 may be regarded as an averaged showing speed calculated from the viewing histories as to the three persons, the motion picture may be shown at the showing speed calculated by this averaging method.

In the above explanations, there is no description as to an example of a method for calculating time sections during which pictures are not viewed, but skipped. The calculation method in this case may be similarly carried out by regarding, for example, a skipped time section during which a showing speed was infinite, namely, regarding this skipped time section as zero in the graph of the reciprocal as shown in FIG. 7.

Alternatively, while the respective viewing histories are not merely shown by the motion picture storage apparatus according to the present invention, or the average of these viewing histories is not simply shown with respect to the subject program, the showing speeds may be controlled by providing several modes. This example will now be explained.

For instance, a time section in which values of the broken line, the dotted line, the dot/dash line, or the thick line (namely, averaged value thereof) are smaller than 0.5 corresponds to a triple showing speed. Similarly, a time section in which values of the broken line, the dotted line, the dot/dash line, or the thick line (namely, average value thereof) are larger than, or equal to 0.5 and smaller than 1 corresponds to a double showing speed. Also, a time section in which values of the broken line, the dotted line, the dot/dash line, or the thick line (namely, average value thereof) are larger than, or equal to 1 corresponds to a half showing speed, namely a slow showing speed.

The above-explained calculations may be carried out by the motion picture storage apparatus 202 of FIG. 4 as explained in the above example, or by another storage-purpose server (not shown) connected to the network 203.

As previously described, while the user selects the own favorite items from either the plural specifying information or the plural viewing histories, otherwise, the user produces the new specifying information by statistical synthesizing operation as to either the plural specifying information or the plural viewing histories, the showing speed for the section during which the subject program should be shown, or the showing speeds every section are controlled based upon this newly-produced specifying information. As a consequence, the important scenes contained in the subject program can be effectively shown without requiring the complex operation in accordance with the trend of the single third party, or the trends of the plural third parties.

As previously explained, the motion picture storage apparatus according to the second embodiment acquires “specifying information” from the external source, and checks as to whether or not the scene indicated by this “specifying information” has been stored, and then when this scene has been stored, the motion picture storage apparatus issues the notification to the user.

As a consequence, the user can readily view the scene in which this user has a great interest.

Second Embodiment

(Outline)

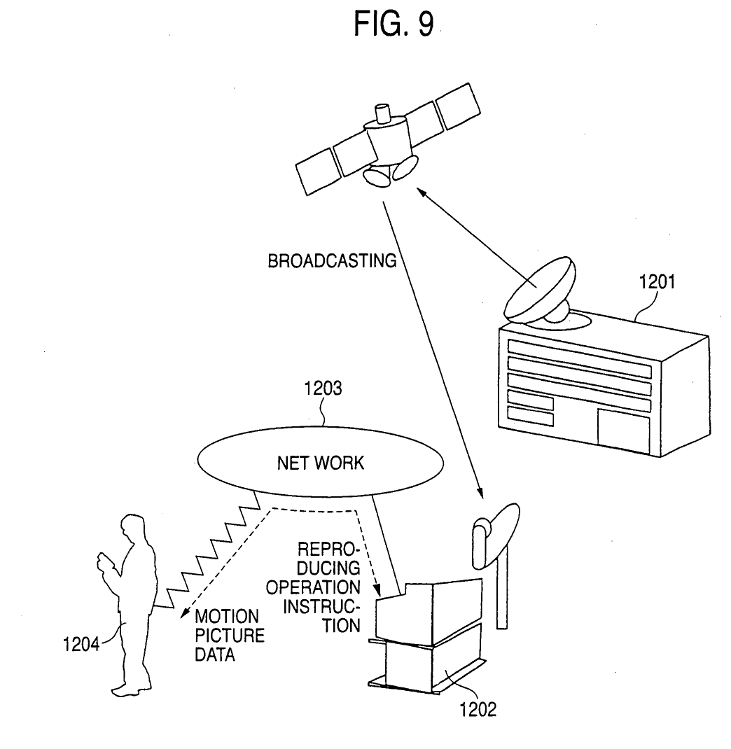

FIG. 9 is an explanatory diagram for explaining an example of a system with employment of a motion picture storage apparatus 1202 according to a second embodiment of the present invention.

This motion picture storage apparatus 1202 receives motion picture data and then stores the received motion picture data, while the motion picture data are distributed by a contents service provider (CSP) 1201 by way of a broadcasting method, or a communication method. Then, the motion picture storage apparatus 1202 converts a coding system of the stored data (in other words, “transcodes the stored data”), and transmits the transcoded motion picture data via a network 1203 to a user's portable viewing device 1204 in response to a request of this user.

The motion picture storage apparatus 1202 receives motion picture data coded by the MPEG-2 system, which is distributed from a broadcasting station and/or a communication station, and then stores thereinto the received motion picture coded data. Then, in response to a request issued from the user's portable viewing device 1204 by a user, this motion picture storage apparatus 1202 transcodes this MPEG-2-coded motion picture data into MPEG-4-coded motion picture data, and transmits this MPEG-4-coded motion picture data to the portable viewing device 1204.

The motion picture storage apparatus 1202 once stores thereinto the request which is transmitted by the user from the portable viewing device 1204. In this case, the contents to be stored are such requests related to viewing operations of motion pictures, for example, “start to show motion picture called as <movie A> from 2:34”, “fast-view motion picture called as <music show B> from 23:45”, “stop viewing of motion picture called as <drama C> at 34:56”, and so on.

Then, the motion picture storage apparatus 1202 produces a viewing history of the user from the information which has been stored in a periodic manner, or at arbitrary timing, and then stores thereinto this produced viewing history. In this case, contents to be produced correspond to such information as, for example, [file name: <movie_A>, status: viewed, viewing section: 00:01:23 to 00:12:34 (normal viewing speed)].

The viewing history which has been produced and stored in this case may be utilized as, for example, reference information when the user selects such a motion picture which will be then viewed. Otherwise, this viewing history may be utilized as a material when a specific showing menu (will be referred to as “specifying information” hereinafter) is produced based upon viewing histories such as “continued to preceding time”, “same method as that of preceding time”, and “portion which has been skipped over in preceding time”.

Since the user refers to viewing history information so as to select the motion pictures, or utilizes the specifying information based upon the viewing history, the user can easily view a desirable motion picture.

It should be noted that the network 1203 may be freely constituted by a wireless manner and/or a wired manner. Also, a means (communication/broadcasting stations) for distributing a motion picture by the CSP 1201 may be freely constructed of a wireless manner and/or a wired manner.

In this exemplification, the motion picture storage apparatus 1202 is operated as follows: That is, the MPEG-2-coded motion picture data is received/stored, and then is transcoded into the MPEG-4-coded motion picture data so as to transmit this MPEG-4-coded motion picture data to the portable viewing device 1204. However, the present invention is not limited only to this combination of these coding systems of the motion picture data. For instance, the present invention may alternatively employ any other motion picture coding systems in addition to the MPEG-1 system.

(Embodiment 3)

Referring now to drawings, a motion picture storage apparatus according to Embodiment 3 of the present invention will be described.

(Schematic Structure)

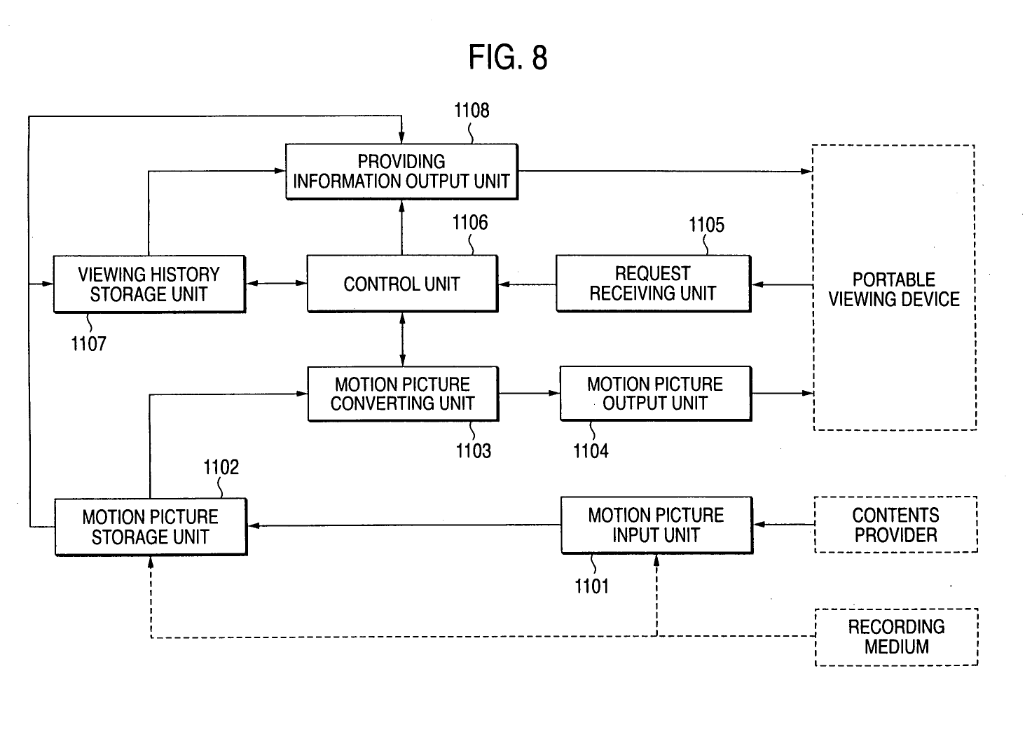

FIG. 8 is an explanatory diagram for explaining a structure of the motion picture storage apparatus according to this Embodiment 3 of the present invention.

The motion picture storage apparatus, according to the Embodiment 3, is provided with a motion picture input unit 1101, a motion picture storage unit 1102, and a request receiving unit 1105. The motion picture input unit 1101 receives coded data of a motion picture from an external source, or inputs thereinto coded data of a motion picture by way of an arbitrary method. The motion picture storage unit 1102 stores thereinto either the received motion picture coded data or the inputted motion picture coded data. The request receiving unit 1105 receives a request from the user.

This motion picture storage apparatus is further equipped with a motion picture transcoding unit 1103, and a motion picture output unit 1104. The motion picture transcoding unit 1103 converts the coding system of the coded data as to the motion picture read out from the motion picture storage unit 1102. The motion picture output unit 1104 transmits the system-converted coded data.

This motion picture storage apparatus is further equipped with a viewing history storage unit 1107, a providing information output unit 1108, and a control unit 1106. The viewing history storage unit 1107 acquires a viewing history from a request content of the user, and then stores thereinto this viewing history. The providing information output unit 1108 outputs both the viewing history and specifying information which is formed based upon this viewing history to the user's portable viewing device. The control unit 1106 controls both the motion picture transcoding unit 1103 and the providing information output unit 1108 in response to a request of the user.

As previously explained, in the motion picture storage apparatus, the viewing history of the user is stored, the specifying information is produced based upon this viewing history, and then is provided to the user. As a result, the user can readily view a desirable picture portion of the motion picture.

(Schematic Operation)

A basic operation of the motion picture storage apparatus according to this Embodiment 3 will now be described.

First, coded data of a motion picture such as a broadcasting program which is transmitted via either a broadcasting station (wired/wireless manners) or a network from the contents provider 1201 is received by the motion picture input unit 1101, and then, the received motion picture coded data is stored in the motion picture storage unit 1102.

The request receiving unit 1105 accepts various requests issued from the user's portable viewing device. These various requests correspond to, for example, a request for transmitting/stopping coded data, a designation as to a coding system and a bit rate, and a request for transmitting list information of stored motion pictures. Then, the request receiving unit 1105 notifies the received request to the control unit 1106.

The control unit 1106 controls the motion picture transcoding unit 1103 based upon the notification issued from the request receiving unit 1105 in such a manner that this motion picture transcoding unit 1103 reads out the coded data from the motion picture storage unit 1102 so as to transcode thereof, and also stores the content of the notification issued from the request receiving unit 1105, namely, the content of the request made by the user into the viewing history storage unit 1107.

The coded data transcoded by the motion picture transcoding unit 1103 is outputted to the portable viewing device of the user by the motion picture output unit 1104.

Both the reading process operation of the coded data and the transcoding process operation are carried out by the motion picture transcing unit 1103 based upon the information notified from the request receiving unit 1105. For instance, both the coded data to be read and the bit rate employed in the coding process operation may become such coded data and bit rate, which are required by the user with respect to the request receiving unit 1105.

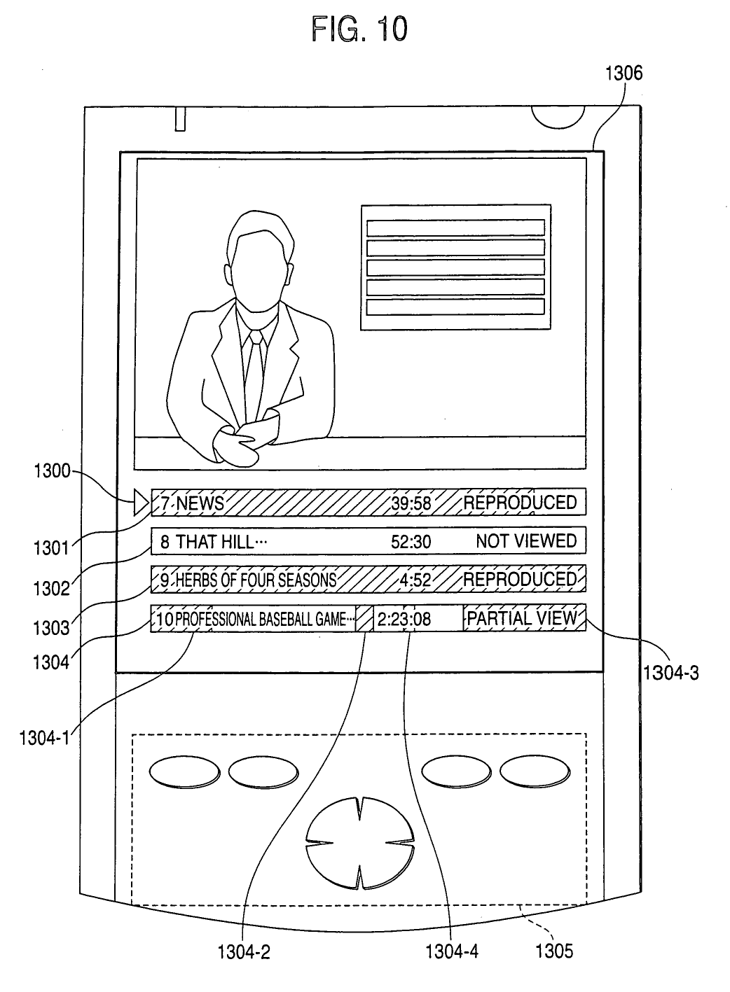

FIG. 10 is a diagram for illustratively showing a portable viewing device which is now showing the coded data of the motion picture transmitted from the motion picture storage apparatus according to this Embodiment 3, and indicates such a condition that a motion picture viewed by the user is tried to be selected.

The user manipulates the portable viewing device by an operation unit 1305 so as to request to receive list information of motion pictures with respect to the motion picture storage apparatus of this Embodiment 3. In response to this request, the motion picture storage apparatus of the Embodiment 3 outputs the list information. In this list information, both information related to a past viewing history and specifying information are contained. The portable viewing device displays such a screen for selecting a motion picture to be viewed on a display screen 1336 by employing the list information.

The user moves a cursor 1300 by using the operation unit 1305 so as to select a motion picture to be viewed from motion pictures 1301, 1302, 1303, and 1304, and then determines the motion picture which will be viewed. Each of these motion pictures 1301, 1302, 1303, and 1304 contains a title of a content, duration, information for indicating whether or not the relevant motion picture has been viewed, and information about a motion picture portion which has been viewed.

In FIG. 10, the information as to the motion picture portions which have been viewed are provided as bar-chart information. A left end of these bars constitutes a starting time of a motion picture, and a right end thereof constitutes an end time of this motion picture. Then, assuming now that an entire motion picture is assumed as 100%, a motion picture portion which has already been viewed, and another motion picture portion which has not yet been viewed are colored in different colors. It should be understood that in this bar chart of FIG. 10, the motion picture portion which has already been viewed is represented by a shade, whereas the motion picture portion which has not yet been viewed is represented by not being painted over with color.

For instance, since the entire portion of the motion picture 1303 has already been viewed, the entire bar thereof is shaded. On the other hand, since the motion picture 1302 has not at all been viewed, the entire bar thereof is not painted over with color. Since a picture portion defined from a first portion up to approximately 80% portions as to the motion picture 1301 has already been viewed, a bar thereof defined from a left end up to approximately 80% thereof are shaded. Since the motion picture 1304 has partially been viewed, picture portions 1304-1, 1304-2, 1304-3, and 1304-4 are shaded, which correspond to the picture portions which have already been viewed.

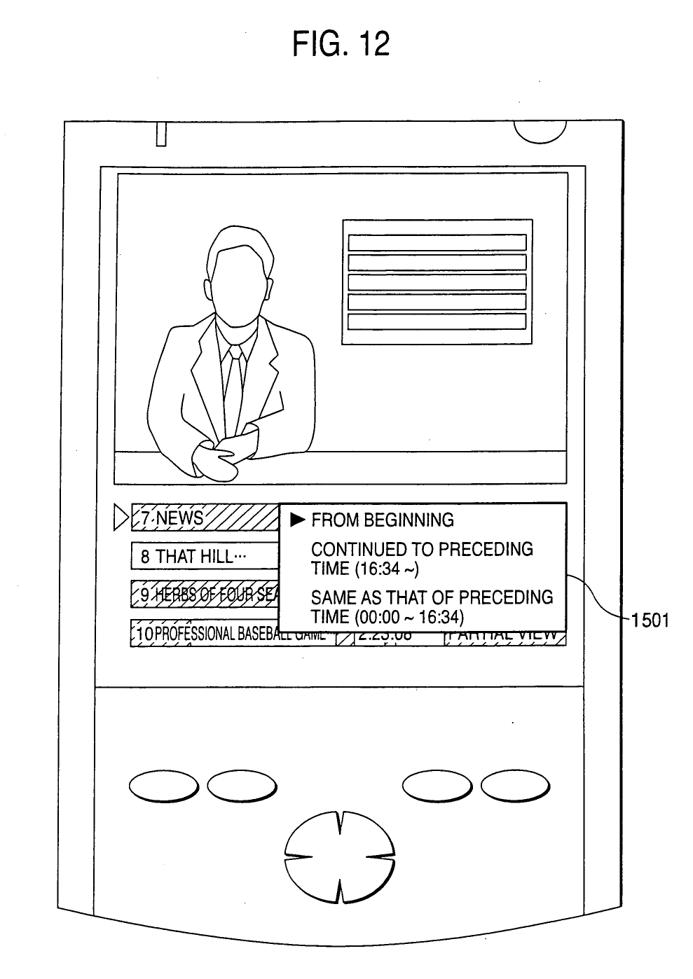

FIG. 12 indicates such a condition that after the motion picture 1303 has been selected, a viewing menu 1501 made based upon specifying information is provided. In this case, three different menus of “from beginning”, “right after previously viewed”, and “same as previously viewed” are provided based upon the specifying information. The user may select how to view a motion picture portion.

The user selects a motion picture to be viewed with reference to the above-described information, and thus, requests the motion picture storage apparatus of this Embodiment 3 to transmit coded data of this selected motion picture.

It should also be noted that when the motion picture storage apparatus of this Embodiment 3 is used at first, there are some possibilities that neither specifying information nor a viewing history is present. Similarly, as to such a motion picture data which has been just newly stored, there are some possibilities that both specifying information and a viewing history of this motion picture data are not present.

In these specific cases, the motion picture storage apparatus handles these motion picture data in such a manner that these motion pictures have not at all been viewed in the past in a first viewing operation. If a viewing operation is once carried out, then a viewing history is produced and stored. As a result, the viewing history and the specifying information may be utilized from the subsequent viewing operation.

(Motion Picture Input Unit 1101)

The motion picture input unit 1101 receives the MPEG-2-coded motion picture data, which has been transmitted from the broadcasting station, or the communication station. Then, the motion picture input unit 1101 sequentially outputs the received coded data to the motion picture storage unit 1102.

As to coded data which is entered into the motion picture input unit 1101, such coded data may be employed which have been stored in hard disks, optical disks, or semiconductor memory devices as an electronic file. Alternatively, such coded data may be similarly employed which are transmitted by way of a streaming distribution, a digital broadcasting system, an e-mail, or by using electromagnetic transmission.

Also, it is so assumed that in this Embodiment 3, the coded data of the motion picture which is distributed corresponds to such a data coded by the MPEG-2 system. However, data coded by other coding systems (for example, MPEG-1 system and MPEG-4.H264 system) may be alternatively employed.

Also, not only such a coded data, but also motion picture maybe distributed as analog signal. In the case that an analog motion picture is employed, this analog motion picture is coded by the motion picture input unit 1101, and thereafter, the coded motion picture data is outputted to the motion picture storage unit 1102. It should be understood that as the coding system of this analog case, an arbitrary coding system may be employed in a similar manner to the above-explained case, but the MPEG-2 coding system is employed in this Embodiment 3.

Further, the motion pictures (irrespective of analog motion picture and coded data) to be distributed may have been encrypted (including scrambled). In this alternative case, these encrypted motion pictures are decrypted/restored in the motion picture input unit 1101.

(Motion Picture Storage Unit 1102)

The motion picture storage unit 1102 corresponds to a storage apparatus for storing thereinto the MPEG-2-coded data, which is received by the motion picture input unit 1101.

This storage apparatus corresponds to such a storage apparatus as, for example, a hard disk drive, an optical disk drive, and a semiconductor memory device. It is so assumed that a hard disk drive is employed in this Embodiment 3. The MPEG-2-coded data which is received by the motion picture storage unit 1102 is stored in this hard disk drive.

It should also be noted that when a program is provided in the form of such a recording medium containing an optical disk, a semiconductor memory device, or a hard disk, the content (program) of this recording medium may be read by the motion picture input unit 1101 and then this read content maybe copied in the motion picture storage unit 1102. Alternatively, the recording medium itself may be utilized as the motion picture storage unit 1102.

(Motion Picture Transcoding Unit 1103)

The motion picture transcoing unit 1103 is a transcoder which converts the data coded by the MPEG-2 system into MPEG-4 type coded data (namely, motion picture data which has been coded by MPEG-4 system).

The motion picture transcoding unit 1103 reads out coded data of a motion picture requested by the user from the motion picture storage unit 1102 in response to an instruction issued from the control unit 1106. Then, this motion picture transcoding unit 1103 transcodes the MPEG-2-coded data into MPEG-4-coded data in response to an instruction (for example, instruction of bit rate) issued from the control unit 1106.

The motion picture transcoding unit 1103 notifies a status to the control unit 1106 in the case that this motion picture transcoding unit 1103 receives an instruction from the control unit 1106, in the case that this motion picture transcoding unit 1103 receives a status confirmation, when an error occurs, and in the case that the motion picture transcoding unit 1103 completes the transcoding operation as to the last picture portion of the motion picture. Contents statuses are “under transcodingof 12:34”, “transcoding up to 12:34 is ended”, “file named as <movie A> does not exist”, “transcoding until last motion picture is complete”, and so on.

For instance, in such a case that such an instruction “execute transcoding of file named as <movie A>” is issued from the control unit 1106, the motion picture transcoding unit 1103 searches the relevant file from the motion picture storage unit 1102, and reads this file so as to transcode this file. Also, in the case that a specific portion of a specific file is designated by the control unit 1106, for example, “execute transcoding of file named as <movie A> defined from 12 minute 34 second up to 23 minute 45 second” is designated, the motion picture transcoding unit 1103 searches the specific file from the motion picture storage unit 1102, and reads this file so as to transcode this specific file.

Also, in such a case that the user wants to perform an “n-multiple speed” viewing operation, the user manipulates the portable viewing device by employing the operation unit 1305 in order to notify such an indication of “n-multiple speed” viewing operation via the control unit 1106 to the motion picture transcoding unit 1103. Thus, the motion picture transcoding unit 1103 transcodes while previously performing the frame skipping operation in order that the motion picture data may be readily shown in the “n-multiple speed”. Since the above-explained transcoding operation is carried out, a total amount of the coded data which is transmitted to the portable viewing device can be reduced, the resulting communication band can be saved and also the image quality can be improved.

Furthermore, in the case that the user wants to perform a viewing operation along a reverse direction, the user similarly manipulates the portable viewing device by using the operation unit 1305 in order that a message of “reverse direction” is notified via the control unit 1106 to the motion picture transcoding unit 1103. The motion picture transcoding unit 1103 reads out the coded data from the motion picture storage unit 1102 along the reverse direction so as to perform the transcoding as to this read coded data.

It should also be noted that in this Embodiment 3, the motion picture transcoding unit 1103 transcodes the MPEG-2-coded data into the MPEG-4-coded data. Alternatively, the motion picture transcoding unit 1103 may be arranged in such a way that the MPEG-2 coding system may be transcoded into other coding systems (for example, MPEG-1, and MPEG-2, H1264). Further, the motion picture transcoding unit 1103 may be so arranged by that a plurality of coding systems may be handled. In this alternative case, the user may freely select a desirable coding system via the control unit 1106.

In such a case that a plurality of coding systems are supported, while the motion picture transcoding unit 1103 is arranged by providing both a memory and a CPU, if a coding function is realized by way of software, then this plural coding function may be easily installed in the memory.

(Motion Picture Output Unit 1104)

The motion picture output unit 1104 outputs the coded data which is produced by the motion picture transcoding unit 1103 to the portable viewing device.

(Request Receiving Unit 1105)

The request receiving unit 1105 establishes a communication with the portable viewing device of the user so as to receive various requests from the user. Then, the request receiving unit 1105 notifies the received request to the control unit 1106.

The requests from the user contain, for example, the above-explained request for transmitting the coded data, the above-described designation of the coding system and the bit rate, and further more, a request to send information (for example, titles of motion pictures, viewing sections thereof, past viewing histories thereof) related to motion pictures which have been stored and are employed when a user selects a desirable motion picture, detailed contents of viewing operations (for example, fast-forward viewing operation, skipping operation, and rewind viewing operation), and the like.

The contents of the requests involve, for instance, [request: viewing, section: 01:23:45—bit rate: 1000 Kbps], [request: double-viewing speed, section: 01:23:45 to 01:34:56, bit rate: 300 Kbps], and the like.

(Control Unit 1106)

The control unit 1106 controls both the motion picture transcoding unit 1103 and the providing information output unit 1108 based upon a request of the user, which is received via the request receiving unit 1105.

The control unit 1106 firstly analyzes the request of the user. In such a case that the request issued from the user corresponds to a request for sending information related to the stored motion picture, the control unit 1106 controls the providing information output unit 1108 to produce the information related to the motion picture, and then transmits this produced information to the user's portable viewing device.

On the other hand, in the case that the request issued from the user corresponds to a request related to a transmission of coded data as explained as, for instance, the request for sending the coded data, the control unit 1106 transmits an instruction to the motion picture transcoding unit 1103 so as to control this motion picture transcoding unit 1103, so that the motion picture transcoding unit 1103 transcodes the coded data read from the motion picture storage unit 1102, and then, transmits this transcoded coded data to the user's portable viewing device.

Then, the control unit 1106 receives a status corresponding to the instruction transmitted to the motion picture transcoding unit 1103, and complements, or completes the request of the user by using the status if necessary, and then, notifies the request of the user to the viewing history storage unit 1107.

The necessity of complementing the request of the user is made in such a case that, for example, a request of “stop viewing” is issued. When such a request of “stop viewing” is made, there is a small possibility that a designation is made which designates that the viewing operation is stopped at which point of a motion picture. Most of the request “stop viewing” implies “immediately stop.”

When a viewing history is formed, such an information “where viewing operation is stopped” is required. Then, the control unit 1106 refers to a status which has been received from the motion picture transcoding unit 1103 so as to extract such an information “where viewing operation is stopped”, and also, notifies both the extracted information and the request of the user to the viewing history storage unit 1107.

For instance, in such a case that the control unit 1106 receives such a request “request: stop” from the user and such an information “stop at 01:23:45” is contained in the status received from the motion picture transcoding unit 1103, the control unit 1106 complements the request issued from the user as “request: stop, section: 01:23:45”, and then notifies the complemented request to the viewing history storage unit 1107.

Also, in the case that a notification of “end viewing operation” is received from the motion picture transcoding unit 1103, the control unit 1106 notifies this fact to the viewing history storage unit 1107.

(Viewing History Storage Unit 1107)

In the viewing history storage unit 1107, a viewing history is produced by employing a request issued from the user, which is notified from the control unit 1106, and then this stored viewing history is stored.

Since such an information “what time and what is done” (for instance, information as to viewing start time and viewing end time) is solely present in an request issued from the user, if this information is directly analyzed, then the control unit 1106 can hardly grasps that how the user has viewed which section of the motion picture.

For example, it is so assumed that the following requests are issued, namely “request: viewing, section: 00:00:00-”, “request: stop, section: 00:12:31”, “request: viewing, section: 00:10:11-”, and “request: stop, section: 00:32:41.” Even if these requests are arrayed in a separate manner, then the control unit 1106 can immediately and hardly grasp “sections 00:00:00 to 00:32:41 have already been viewed.” Therefore, the requests of the user are combined with each other so as to form a viewing history by which the following fact can be immediately understood, namely “sections 00:00:00 to 00:32:41 have already been viewed.”

Upon receipt of both the request of the user and the notification “end viewing” from the control unit 1106, the viewing history storage unit 1107 refers to the past viewing histories, and produces a viewing history, and then, stores thereinto this produced viewing history.

The stored viewing history is provided to the providing information output unit 1108 so as to be employed as reference information when the user selects the motion picture. Alternatively, this stored viewing history is employed as such an information which constitutes basic information when specific specifying information such as “continue to preceding time”, “same as preceding time”, and “place which has been skipped in preceding time” is provided.

The contents of the viewing histories correspond to the following information, for instance, “file name: <movie_A>, status: has been viewed, viewing section: 01:23:45 to 01:34:56 (normal viewing speed)”, “file name: <drama B>, status: has not yet been viewed”, “file name: <news C>, status: scanning view, viewing section: 00:01:23 to 00:12:34 (double viewing speed)”, “file name: <baseball D>, status: partially viewed, viewing sections: 00:34:56 to 00:45:12 (double viewing speed)/00:56:01 to 01:01:23 (normal viewing speed)”, and so on.

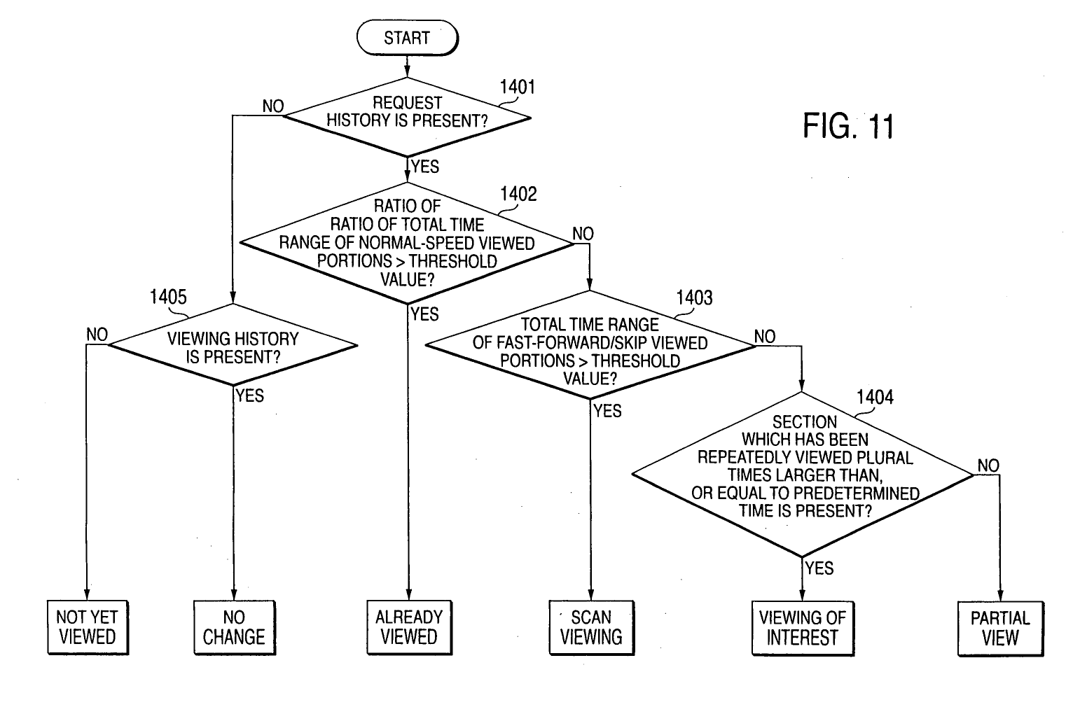

Next, a description is made of a process operation for producing a viewing history. FIG. 11 is an explanatory diagram for explaining a producing process flow operation of a viewing history.

First, a check is made as to whether or not a request history as to a file of a certain motion picture is present (step 1401). If this request history is not present, then another check is made as to whether or not a viewing history as to this motion picture file is present (step 1405).

When neither the request history nor the viewing history is present, while a status is set as “not yet viewed”, a viewing history is newly produced. Then, the producing process operation defined in the step 1401 is carried out with respect to the next motion picture. On the other hand, in such a case that although a request history of this next motion picture is not present, but a viewing history thereof is present, this case implies that there is no change in the viewing history. As a result, no specific process operation is carried out, but the process operation of this step 1401 is carried out as to the next motion picture.

In the case that the request history is present, a check is made as to whether or not a ratio of total time range of normal-speed viewed portions against that of entire duration is larger than a predetermined threshold value (step 1402). When this ratio is larger than a predetermined threshold value, the status of the viewing history is set to “has been viewed.”

In the case that the above-described ratio is smaller than, or equal to the predetermined threshold value, another check is made as to a ratio of total time range of fast-forward/skip viewed portions against that of entire duration is larger than a predetermined threshold value (step 1403). In the case that this ratio is larger than the predetermined threshold value, a status of the viewing history is set to “scan viewing.”

In such a case that the above-described ratio is smaller than, or equal to the predetermined threshold value, another check is made as to whether or not there is a section within the entire section of this motion picture, which has been repeatedly viewed plural times larger than, or equal to a predetermined time (step 1404). If there is such a repeatedly-viewed section, then the status of the viewing history is set to “viewing with interest.” If there is no such a repeatedly-viewed section, then the status of the viewing history is set to “partial viewing.”

It should also be understood that the predetermined threshold value related to the above-explained normal viewing operation, the predetermined threshold value related to the above-explained fast-forward/skip viewing time, and the predetermined number as to the above-described repeatedly-viewing operations may be previously determined when the motion picture storage apparatus of this Embodiment 3 is designed, for example, these threshold values/number may be determined as such fixed values, namely 70% of entire normal viewing operation, 50% of the entire viewing time, and three times. Otherwise, these threshold values/time may be determined based upon desirable aspects of the user.

(Providing Information Output Unit 1108)

The providing information output unit 1108 receives an instruction issued from the control unit 1106, and produces such an information which is provided to the portable viewing device, and then outputs this produced information.

Upon receipt of the instruction issued from the control unit 1106, the providing information output unit 1108 acquires both the list information of the motion pictures stored in the motion picture storage unit 1102 and the viewing history information stored in the viewing history storage unit 1107. Then, this providing information output unit 1108 produces specifying information based upon the acquired viewing history.

In the case that the user firstly accesses the motion picture storage apparatus of this Embodiment 3, or in the case that motion picture data has just newly been stored, there are some possibilities that a viewing history is not present. When such a viewing history is not present, all of these motion pictures are handled as “not yet being viewed.”

In the case of a motion picture having such a viewing history as, for instance, “file name: <movie_A>, status: scan viewing, viewing section: 01:23:45 to 01:34:56 (double viewing speed)”, a viewing method to which the user owns large needs may be conceived from any one of “view from beginning picture portion”, “view motion picture portion from 00:56:12 corresponding to the time when previously suspended viewing”, “view motion picture portion from 00:12:34 same as previously viewed”, and also “view motion picture portion from 00:12:34 same as previously viewed at double viewing speed.”

As a consequence, the providing information output unit 1108 produces specifying information such as “show/view motion picture portion from 01:23:45 of file called as <movie_A>”, and “show/view motion picture portion from 00:12:34 of file called as <drama_B> at double showing/viewing speed” based upon the viewing history.

Then, the providing information output unit 1108 produces information to be outputted based on the list information, the viewing history information, and the specifying information. The information to be outputted may involve a file name, either a program name or a title, duration of this motion picture, a viewing history, and specifying information.

It should also be noted that there is no limitation in output formats of information. A program name, a title, duration, a viewing history, and the like are required to be shown to the user. However, there is a small necessity to show a file name and specifying information themselves (corresponding to above-described specifying information [show/view motion picture portion from 01:23:45 of file called as <movie_A>]). As a consequence, the following method is preferable. That is, while the specifying information is described by using, for example, an <INPUT> tag of the HIDDEN attribute of the HTML, when the user selects this tag, the hidden information is also transmitted.

(Effects of Embodiment 3)

As previously described, in accordance with this embodiment, the viewing history is produced from the request which is transmitted to the motion picture storage apparatus by the user, and then, the specifying information indicative of the specific picture portion of the motion picture is produced based upon the viewing history. As a consequence, the user can easily view the motion picture based upon the past viewing history.

(Modification 1)

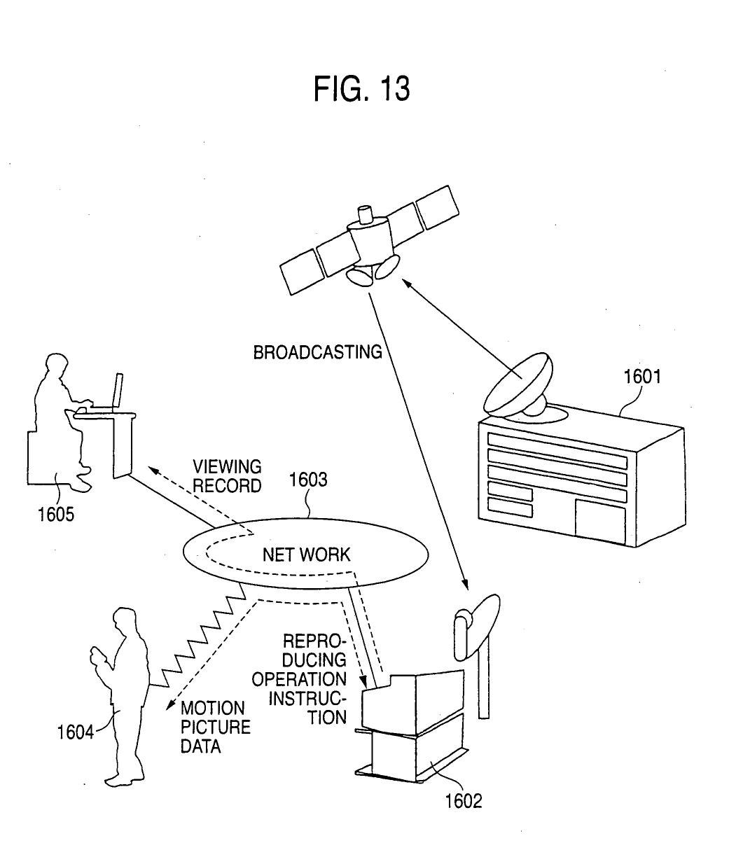

FIG. 13 is a diagram for explaining an example of a system with employment of a motion picture apparatus according to a first modification of the Embodiment 3.

The motion picture storage apparatus of this embodiment 1 is equipped with a function capable of transmitting a viewing history which has been stored in a viewing history storage unit 1107 of a motion picture storage apparatus 1602 via a network 1603 to an externally-provided viewing history investigating terminal 1605.

This modification 1 is suitable for such a motion picture apparatus which checks as to whether or not, for example, a student for a lecture in a communication course views a text material, or which investigates that listeners have the greatest interest in which scene of which program in an audience rating investigation of broadcasting programs.

It should be understood that although the viewing history investigating terminal 1605 and the contents provider 1601 are described as separate subjects in this modification 1, these terminal 1605 and provider 1601 may be constituted as the same subject.

(Modification 2)

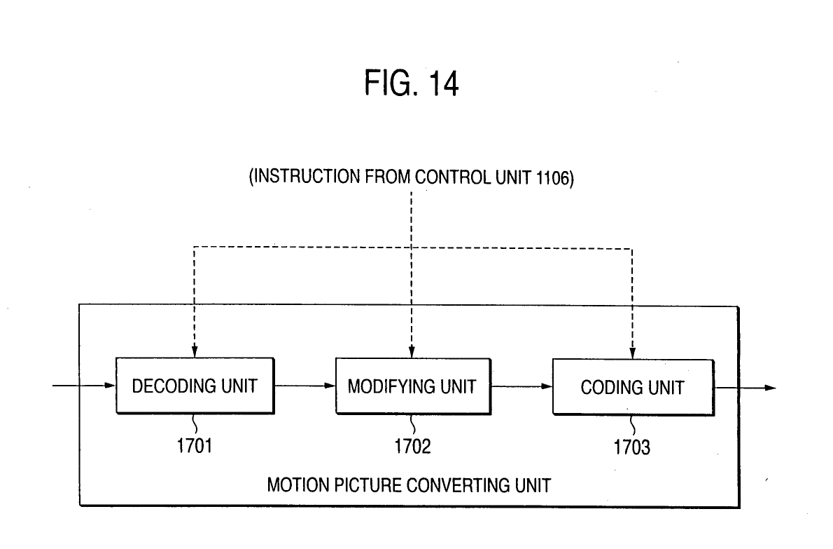

FIG. 14 is a block diagram for indicating an arrangement of a motion picture transcoding unit, which is constituted by modifying the arrangement of the above-described motion picture transcoding unit 1103 of the motion picture storage apparatus according to Embodiment 3. The motion picture transcoding unit of this modification 2 is equipped with a decoding unit 1701, a modifying unit 1702, and an encoding unit 1703, and is capable of performing a modification of a motion picture when a coding system of a motion picture is converted.

Any of the decoding unit 1701, the modifying unit 1702, and the encoding unit 1703 may receive an instruction issued from the control unit 1106. For instance, the decoding unit 1701 reads out motion picture data which will be decoded in response to the instruction of the control unit 1106, whereas, for example, the encoding unit 1703 changes a bit rate and a coding system in response to the instruction of the control unit 1106.

The modifying unit 1702 performs various modifications such as an enlargement, a compression, a cut-out, and a rotation of a specific portion of a motion picture in response to the instruction issued from the control unit 1106.

In the motion picture storage apparatus of this modification 2, the request receiving unit 1105 also receives a request of modifying a motion picture issued from the user. Then, in order to accept this modification request, an instruction is sent from the control unit 1106 to the modifying unit 1702 so as to cause this modifying unit 1702 to execute a modification process operation.

In the motion picture storage apparatus of this modification 2, the modification request as to the motion picture issued from the user is also recorded in addition to the viewing history. Then, specifying information containing also a history of the modification request is produced. As a result, in such a case that the user selects the above-explained “viewing same as previously viewed”, the modification process operation may also be reproduced in response to the modification request.

For example, it is so assumed that when a user views a soccer game on a certain day, this user views the soccer game while an area around a ball is enlarged. Next, when the user views the same soccer game, if this user selects “viewing same as previously viewed”, then the user can view this soccer game under such a condition that the peripheral area of the ball is automatically enlarged.

(Modification 3)

In the modification 2, the modification process operation has been reproduced based upon the history of the modification request. Other than this operation, when the user views a motion picture corresponding to the above-explained “view of interest”, a modification such as an enlargement may be automatically carried out when a section where the “view of interest” has been carried out is reproduced.

(Modification 4)

Alternatively, the providing information output unit 1108 may produce/provide such a specifying information which corresponds to “view from first motion picture portion with respect to viewing history.”

This viewing method is to realize the below-mentioned viewing method. That is, although the user views the motion picture from the first motion picture portion, showing methods of specific sections are properly switched based upon a viewing history. For example, a motion picture portion which has already been viewed is fast-forward shown, or skipped, or a motion picture portion which was fast-forward shown, or skipped in the previous viewing, is shown at the normal viewing speed in the present time.

(Modification 5)

In this embodiment, specifying information produced in the providing information output unit 1108 is transmitted to the user's portable viewing device. While this specifying information is stored on the side of the motion picture storage apparatus, an identifier which is properly allocated to the specifying information may be alternatively transmitted to the user's portable viewing terminal.

(Modification 6)

In this embodiment, after the request of the user has been complemented based up on the status in the control unit 1106, this complemented request is notified to the viewing history storage unit 1107. Alternatively, the motion picture storage apparatus may be arranged as follows. That is, while the status is notified to the viewing history storage unit 1107 in combination with the request of the user, when the viewing history is produced in the viewing history storage unit 1107, this viewing history storage unit 1107 may refer to this status.

1. A motion picture storage apparatus, comprising:
a motion picture input unit which inputs motion picture data;
a motion picture storage unit which sequentially stores the motion picture data;
a condition storage unit which stores a condition related to a desirable scene previously set by a user;
a motion picture analyzing unit configured to analyze the motion picture data stored in the motion picture storage unit to check whether a scene satisfying the condition is present, and configured to acquire specifying information of the scene satisfying the condition when the scene satisfying the condition is present; and
an information notifying unit which notifies the specifying information to a device of the user.

2. The motion picture storage apparatus as claimed in claim 1, further comprising:
a motion picture output unit which outputs the motion picture data stored in the motion picture storage unit to a device designated by the user;
wherein, when the specifying information is designated by the user, the motion picture output unit outputs motion picture data of a scene designated by the specifying information.

3. The motion picture storage apparatus as claimed in claim 2,
wherein the condition storage unit further stores a modification condition previously set by the user, for modifying a motion picture of the desirable scene; and
the motion picture output unit modifies the motion picture data of the scene designated by the specifying information in accordance with the modification condition and outputs the modified motion picture data to the device of the user.

4. The motion picture storage apparatus as claimed in claim 1, wherein the motion picture data inputted by the motion picture input unit include at least one of a motion picture, coded data of the motion picture, and coded data of metadata containing the motion picture.

5. A motion picture storage apparatus comprising:
a motion picture input unit which inputs motion picture data including at least one of a motion picture, coded data of the motion picture, and coded data of metadata containing the motion picture;
a motion picture storage unit which sequentially stores the motion picture data;
a condition storage unit which stores a condition related to a desirable scene previously set by a user;
a motion picture analyzing unit configured to analyze the motion picture data stored in the motion picture storage unit to check whether a scene satisfying the condition is present, and configured to acquire specifying information of the scene satisfying the condition when the scene satisfying the condition is present; and
a motion picture output unit which outputs to a device of the user motion picture data of the scene designated by the specifying information when the scene satisfying the condition is contained in the motion picture data analyzed by the motion picture analyzing unit.

6. The motion picture storage apparatus as claimed in claim 5, wherein the motion picture output unit outputs the motion picture data after a data format of the motion picture data has been converted into a data format preset by the user.

7. The motion picture storage apparatus as claimed in claim 5,
wherein the motion picture input unit receives motion picture data including sound data and picture data; and
the motion picture analyzing unit analyzes the sound data and the picture data.

8. A motion picture storage apparatus, comprising:
a motion picture input unit which inputs motion picture data;
a motion picture storage unit which sequentially stores the motion picture data;
a specifying information receiving unit which receives specifying information for designating a specific scene of a motion picture;
a motion picture analyzing unit which analyzes the motion picture data stored in the motion picture storage unit to check whether a scene corresponding to the specifying information is present; and
an information notifying unit which notifies to a device of a user the fact that the scene corresponding to the specifying information is present when the scene corresponding to the specifying information is present.

9. The motion picture storage apparatus as claimed in claim 8, wherein the motion picture data inputted by the motion picture input unit include one of a motion picture, coded data of the motion picture, and coded data of metadata containing the motion picture.

10. The motion picture storage apparatus as claimed in claim 8, wherein the specifying information receiving unit acquires the specifying information from an external server previously designated by the user, when the present time reaches a time instant preset by the user.

11. A motion picture storage apparatus, comprising:
a motion picture input unit which inputs motion picture data including one of a motion picture, coded data of the motion picture, and coded data of metadata containing the motion picture;
a motion picture storage unit which sequentially stores the motion picture data;
a specifying information receiving unit which receives specifying information for designating a specific scene of a motion picture;
a motion picture analyzing unit which analyzes the motion picture data stored in the motion picture storage unit to check whether a scene corresponding to the specifying information is present; and
an information notifying unit which notifies the specifying information to a device of a user when the scene corresponding to the specifying information is present.

12. The motion picture storage apparatus as claimed in claim 9, further comprising: a motion picture output unit which outputs the motion picture data stored in the motion picture storage unit to a device designated by the user;
wherein the motion picture output unit outputs motion picture data of a scene designated by the specifying information when the specifying information is designated by the user.

13. A motion picture storage apparatus, comprising:
a motion picture input unit which inputs motion picture data including one of a motion picture, coded data of the motion picture, and coded data of metadata containing the motion picture;
a motion picture storage unit which sequentially stores the motion picture data;
a specifying information receiving unit which receives specifying information for designating a specific scene of a motion picture;
a motion picture analyzing unit which analyzes the motion picture data stored in the motion picture storage unit to check whether a scene corresponding to the specifying information is present; and
a motion picture transmitting unit which transmits to a device of the user motion picture data of the scene corresponding to the specifying information when the scene corresponding to the specifying information is present.

14. The motion picture storage apparatus as claimed in claim 13, wherein the specifying information receiving unit further receives modification information for modifying the specific scene; and
the motion picture output unit modifies the motion picture in accordance with the modification information and outputs the modified motion picture.

15. A motion picture distributing system comprising:
a distributing server which distributes motion picture data;
an information server which distributes specifying information for designating a specific scene of the motion picture data; and
a storage server which receives the motion picture data distributed from the distributing server and the specifying information distributed the information server and which stores the motion picture data and the specifying information; and
a reproducing device which reproduces the motion picture data read from the storage server;
wherein the distributing server, the information server,
the storage server, and the reproducing device are connected with each other;
the storage server checks whether a scene designated by the received specifying information is stored; and,
when the designated scene is stored, the storage server notifies to the reproducing device the fact received specifying information is stored.

16. The motion picture distributing system as claimed in claim 15,
wherein, when the storage server stores the scene designated by the received specifying information, the storage server notifies the specifying information to the reproducing device; and
the reproducing device reads out the motion picture of the scene according to the specifying information.

17. The motion picture distributing system as claimed in claim 15, wherein the storage server acquires the specifying information from the information server when a preset time has passed or at a predetermined time instant.

18. A motion picture storage apparatus for storing motion picture data to provide the motion picture data to a reproducing device of a user, comprising:
a storage unit which stores first coded data of a first coding system;
a request accepting unit which receives a motion picture data sending request and a motion picture list sending request from the user;
a viewing history producing unit which produces a viewing history from the motion picture data sending request;
a converting unit which converts the first coded data stored in the storage unit into second coded data of a second coding system in response to the motion picture data sending request;
an output unit which outputs the second coded data to the reproducing device; and
a viewing history output unit which outputs the viewing history to the reproducing device in response to the motion picture list sending request.

19. The motion picture storage apparatus as claimed in claim 18, wherein the viewing history includes information indicative of a transition of a method for viewing a motion picture.

20. The motion picture storage apparatus as claimed in claim 18, wherein the viewing history includes information as to at least one of a reproducing starting point, a stop point, a reproducing direction, and a reproducing speed of a motion picture.

21. The motion picture storage apparatus as claimed in claim 18,
wherein the request accepting unit receives a motion picture modifying request;
the converting unit executes a modifying process operation including at least one of an enlargement, a compression, a cut-out, and a rotation with respect to a motion picture according to the motion picture modifying request; and
the viewing history producing unit produces a viewing history including the information indicative of the transition of a viewing method for the motion picture according to the motion picture modifying request and the motion picture data sending request.

22. The motion picture storage apparatus as claimed in claim 19, wherein the viewing history output unit transmits the viewing history to an external apparatus other than the reproducing device in response to a request issued from the external apparatus.

23. A motion picture storage apparatus for storing motion picture data to provide the motion picture data to a reproducing device of a user, comprising:
a storage unit which stores first coded data of a first coding system;
a request accepting unit which receives a motion picture data sending request and a motion picture list sending request from the user;
a viewing history producing unit which produces a viewing history from the motion picture data sending request;
a converting unit which converts the first coded data stored in the storage unit into second coded data of a second coding system in response to the motion picture data sending request;
an output unit which outputs the second coded data to the reproducing device;
a specifying information producing unit which produces specifying information indicative of a specific portion of a motion picture from the viewing history; and
a specifying information output unit which outputs the specifying information to the reproducing device according to the motion picture list sending request.

24. The motion picture storage apparatus as claimed in claim 23, wherein the viewing history includes information indicative of a transition of a method for viewing the motion picture.

25. The motion picture storage apparatus as claimed in claim 23, wherein the specifying information includes specifying information indicative of a picture portion which was not yet viewed in the past and specifying information representative of a picture portion which was already viewed in the past.

26. The motion picture storage apparatus as claimed in claim 24,
wherein the request accepting unit receives a motion picture modifying request;
the converting unit also executes a modifying process operation including at least one of an enlargement, a compression, a cut-out, and a rotation with respect to the motion picture according to the motion picture modifying request; and
the viewing history producing unit produces the viewing history according to the motion picture modifying request and the motion picture data sending request.

27. The motion picture storage apparatus as claimed in claim 26 wherein the specifying information includes information indicative of a picture portion which was viewed in the past, and information relating to a modification which was carried out in the past.

28. The motion picture storage apparatus as claimed in claim 23, wherein the specifying information output unit produces a reproduction menu formed according to the specifying information and outputs the produced reproduction menu.

29. The motion picture storage apparatus as claimed in claim 26, wherein the viewing history output unit transmits the viewing history to an external apparatus in response to a request issued from the external apparatus other than the reproducing device.

30. A motion picture providing method for providing motion picture data to a reproducing device according to a motion picture data sending request transmitted by a user, comprising:
generating a viewing history on the basis of the motion picture data sending request;
receiving a motion picture list sending request from the user;
outputting the viewing history in a form selectable by the user; and
providing the motion picture data to the reproducing device according to a selection by the user from the viewing history.

31. A motion picture providing method for providing motion picture data to a reproducing device according to a motion picture data sending request transmitted by a user, comprising:
generating a viewing history on the basis of the motion picture data sending request;
generating a specifying information for designating a specific motion picture;
receiving a motion picture list sending request from the user;
outputting the viewing history in a form selectable by the user; and
providing the motion picture data of the specific motion picture to the reproducing device according to a selection by the user from the viewing history.

32. A viewing history investigating system, comprising:
a distribution server which distributes motion picture data by the use of broadcasting or communication;
a storage server which receives the motion picture data distributed from the distribution server and stores the received motion picture data;
a reproducing device which acquires the motion picture data from the storage server so as to reproduce the acquired motion picture data; and
an information collecting device;
wherein the distribution server, the information collecting device, the storage server, and the reproducing device are connected with each other;
the storage server receives a request of the reproducing device, converts a coding system of the stored motion picture data, transmits the code-converted motion picture data, and produces a viewing history according to the request of the reproducing device to store the produced viewing history; and
the storage server transmits the viewing history to the information collecting device on receiving a transmission request of the viewing history from the information collecting device.

33. A motion picture outputting apparatus, comprising:
a request accepting unit which receives motion picture data sending requests and motion picture list sending requests sent from a plurality of users;
a viewing history producing unit, which produces a plurality of viewing histories of the plurality of users from the motion picture data sending requests;
a specifying information producing unit which produces specifying information indicative of a specific portion of a motion picture from the plurality of viewing histories;
an output unit which outputs motion picture data to a reproducing device; and
a specifying information output unit which outputs the specifying information to the reproducing device according to the motion picture list sending request.
